(19) United States
(12) Patent Application Publication
(10) Pub. No.: US 2004/0257579 A1
(43) Pub. Date: Dec. 23, 2004

(54) Chemical sensor

(75) Inventors: Masataka Shirai, Higashimurayama (JP); Toshiki Sugawara, Kodaira (JP); Masato Shishikura, Ome (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/852,253

(22) Filed: May 25, 2004

(30) Foreign Application Priority Data
Jun. 18, 2003 (JP) 2003-172774

(51) Int. Cl. G01B 9/02

(52) U.S. Cl. 356/477

(57) ABSTRACT

The object of the invention is to enhance the sensitivity of a chemical sensor. To achieve the object, in a chemical sensor chip formed on a substrate and provided with a Mach-Zehnder interferometer, a part of an optical input waveguide or an optical output waveguide is tapered or the thickness or the width of one of waveguides branched in two from a Y-type branchpoint of the Mach-Zehnder interferometer varies in a taper.

### CLAIM OF PRIORITY

The present application claims priority from Japanese application JP 2003-172774 field on Jun. 18, 2003, the content of which is hereby incorporated by reference into this application.

### FIELD OF THE INVENTION

The present invention relates to a chemical sensor, particularly relates to a sensor for sensing a harmful chemical and harmful pathogenic bacteria in a commercial plant, sensing a harmful chemical and a harmful micro-organism in environment and sensing a chemical and an organism for detecting protein and a pathogenic bacterium related to disease and health at home and in a hospital.

### BACKGROUND OF THE INVENTION

Heretofore, a method of measuring stoichiometric quantities without fluorescent labeling so as to detect the strength of interaction between proteins in an organism and the concentration of protein and other chemicals in an organism and environment is known. A reason why such a sensor that does not use fluorescent labeling is required is as follows. As in a detection method with fluorescent labeling, fluorescent material is directly or indirectly combined with a chemical to be sensed, simple measurement is disabled because of the protocol processing for labeling of the fluorescent material and much time may be required for the protocol processing. Besides, in monitoring of continuously sensing a specific chemical, fluorescent material is required to be continuously reacted and it is not practical. Simultaneously, a problem that the chemical including the fluorescent material flows on the downstream side of a chemical flow system may be also caused. In a method in which no fluorescent material is used, the above-mentioned problem is not caused.

Next, the prior art of a chemical sensor using no fluorescent material and related to the invention will be described. In a method using no fluorescent material, a chemical (a specific receptor) specifically combined with a chemical to be sensed (a target compound) is immobilized on a substrate and it is sensed whether the target compound is combined with the specific receptor or not. The temporal variation of interaction between the target compound and the specific receptor and a binding and dissociation constant can be also measured.

Out of chemical sensing methods utilizing the combination of the specific receptor immobilized on the substrate and the target compound, a method of sensing a response of a refractive index in the vicinity of the surface of the substrate caused when the target compound is combined and adsorbed with/in the specific receptor immobilized on the substrate is known. For the method of sensing a response of the refractive index in the vicinity of the surface of the substrate, two methods of a method of utilizing surface plasmon resonance (for example, refer to L. S. Jung et. al. Langmuir vol. 14p. 5636 (1998)) and a method of sensing the phase response of a beam propagated in an optical waveguide (refer to Analytical Chemistry vol. 57 pp. 1188A (1985)) are known.

In a phase detection method of detecting the phase response of a beam propagated in an optical waveguide, high-sensitive chemical detection is enabled by extending the waveguide to detect a phase response acquired by integrating a response of a refractive index by the length of the waveguide and particularly, a method of using a Mach-Zehnder interferometer is known as the most basic configuration for realizing phase detection (for example, refer to Sensors and Actuators B, 24/25 pp. 762 (1995)).

For such a chemical sensor using a Mach-Zehnder interferometer, well-known technique shown in FIGS. 1, 2 and 3 is known (refer to U.S. Pat. No. 5,465,151, U.S. Pat. No. 6,137,576 and U.S. Pat. No. 6,429,023). The configuration and the operating principle will be described below. A beam outgoing from a single mode laser source 16 is incident on an optical waveguide 501 formed on a substrate via an optical fiber connecting medium such as an optical fiber 106 and optical coupling means 701 for making the beam incident on the optical waveguide on the semiconductor or glass substrate 200 such as a lens and an arrayed fiber. FIG. 3 is a sectional view in a position (a cross-section A′ shown in FIG. 1) in which the beam is incident on the waveguide 501. The waveguide 501 is formed on the substrate 200. An optical beam spot propagated in the waveguide 501 is designed so that the optical beam spot is substantially equivalent, in the form and the size, to a light beam output from the optical coupling means 701. Hereby, a beam from most optical coupling means is input to the waveguide 501. The beam propagated in the optical waveguide 501 is branched into two waveguides 516, 517. FIG. 2 is a cross-sectional view showing a cross-section A shown in FIG. 1 after branching. At this time, the beam propagated in one waveguide 516 passes an area 400 in which a specific receptor 601 that specifically adsorbs a target compound 602 is immobilized on the surface and the beam propagated in the other waveguide 517 is propagated in an area 401 in which the target compound 602 is not adsorbed. These two beams are multiplexed again and are propagated in a waveguide 502. The variation of intensity is caused correspondingly to phase difference between the beam propagated in the waveguide 517 and the beam propagated in the waveguide 516 which respectively interfere in the waveguide in multiplexing. The beam the intensity of which varies is led to a photodetector 40 via beam leading means 702 for leading the beam from the waveguide substrate to a fiber and others (a lens or an arrayed fiber) and beam transmission means 107 such as a fiber and its optical intensity is converted to current.

For a principle of measurement, a phase of the beam that passes one waveguide 516 varies in proportion to an amount in which the target compound 602 is adsorbed and the variation is measured as optical intensity in the photodetector 40 (corresponding to PD1). FIG. 4 shows the variation of optical intensity corresponding to a phase response. The abscissa of the graph shows phase difference between beams propagated in the waveguides 516, 517 and the ordinate shows optical intensity output from the waveguide 502 shown in FIG. 1. A phase response on the abscissa is proportional to an amount of the adsorbed target compound and is converted to the amount of the adsorbed target compound using relation between the phase response measured by another method beforehand and the amount of the adsorbed target compound.

Next, a reason why a phase response is made by the adsorption of a target compound will be described. As shown in FIG. 2 which is a sectional view viewed along the cross-section A shown in FIG. 1, the optical distribution of the beam propagated in the waveguide 516 and in the waveguide 517 slightly sticks out into the areas 400, 401 including a solvent or gas including the target compound 602 from each waveguide, and therefore, when the target compound 602 is combined and adsorbed with/in the specific receptor 601, the refractive index of the beam propagated in the optical waveguide 516 varies in proportion to the adsorbed amount. Further, hereby, a phase response of the beam that passes the area 400 is more than that of the beam that passes the area 401.

According to the above-mentioned principle, the adsorption of the target compound is measured. In case the concentration of target chemicals (or compounds) in solution is measured, calibration by measuring a phase response to a target compound the concentration of which is known is made beforehand concerning relation between an amount of a phase response and an amount of adsorbed compounds.

As described above, it is known that an adsorbed amount of a specific chemical is acquired by measuring an amount of a target compound adsorbed in a specific receptor or concentration in solution using a Mach-Zehnder interferometer.

The conventional type method of measuring a chemical by measuring a response of a refractive index by the absorption of a target compound in a specific receptor has been described above. Except such a method, a method of sensing a chemical by changing not a response of a refractive index caused when a target compound is adsorbed on the surface of the optical wavelength but an absorption coefficient of the optical waveguide is known. In case sensitivity for sensing is short even if the absorption coefficient of only a target compound is changed, a method of sensing a chemical by measuring a response of the absorption coefficient of the optical waveguide by combining a substance (called a marker) that strongly absorbs the beam with a well-known wavelength with the target compound and making a complex of the target compound and the marker be adsorbed on the surface of the optical waveguide is known.

For such a chemical sensor utilizing the change of the absorption coefficient of the optical waveguide, technique having configuration shown in FIGS. 31, 32, 33 is known (for the basic configuration, refer to U.S. Pat. No. 585,438). The configuration and an operating principle will be described below. As in the case of a Mach-Zehnder interferometer, a beam outgoing from a single mode laser source 16 shown in FIG. 31 is incident on an optical waveguide 501 formed on a substrate via optical transmission means such as an optical fiber 106 and means 701 for leading the beam to the optical waveguide on the semiconductor or glass substrate 200 shown in FIGS. 32, 33 such as a lens and an arrayed fiber. FIG. 33 is a sectional view viewed in a position (along a cross-section A′ shown in FIG. 31) in which the beam is led to the waveguide 501. The waveguide 501 is formed on the substrate 200. The light beam propagated in the waveguide 501 is designed so that it is substantially equivalent to a light beam output from the optical coupling means 701 in the form and the size. Hereby, a beam from most optical coupling means is input to the waveguide 501. The beam propagated in the optical waveguide 501 is branched into two waveguides 518, 519.

FIG. 32 shows the sectional structure viewed along a cross-section A shown in FIG. 31 after branching. At this time, the beam propagated in one optical waveguide 518 passes an area 400 in which a specific receptor 601 that specifically adsorbs a target compound 602 is immobilized on the surface and the beam propagated in the other waveguide 519 is propagated in an area 401 in which no target compound 602 is adsorbed. In the area 400 in which the receptor is immobilized, the absorption coefficient increases by the adsorption of the target compound and optical intensity propagated and output in the optical waveguide 518 is weaker than optical intensity output from the optical waveguide 519 via the area 401 in which no specific receptor is immobilized. That is, difference between the optical intensity output from the optical waveguide 519 and the optical intensity output from the optical waveguide 518 is proportional to the adsorbed amount of the target compound. In case the target compound is combined and adsorbed with/in a marker, the target compound can be similarly measured by measuring difference in intensity. The beam output from the two optical waveguides 518, 519 is led to photodetectors 40, 41 via optical coupling means 702, 703 such as a lens and an arrayed fiber and optical transmission means 107, 108 such as a fiber, the optical intensity is converted to current and can be transmitted to an external device.

To convert a response of the refractive index by the adsorption of the target compound to a phase response efficiently as described above, it is effective to thin the optical waveguides 516, 517 by thickness x in FIG. 5 as disclosed in K. Fischer and J. Muller Sensors and Actuators B9, p. 209 (1992), F. Bronsinger, H. Freimuth, M. Lacher, W. Ehrfeld, E. Gedig, A. Katerkamp, F. Spener, K. Cammann Sensors and Actuators B 44 p. 350 (1997), R. G. Heideman, R. P. H. Kooyman and J. Greve Sensors and Actuators B 10 p. 209 (1993). FIG. 5 is a sectional view viewed along the cross-section A shown in FIG. 1 for sensing a chemical. When the waveguide is thinned up to a limit at which no beam is propagated, the optical intensity of the evanescent field in which the specific receptors are immobilized increases and a response of the refractive index by the adsorption of the target compound is converted to a phase response of the beam propagated in the optical waveguide. For the thickness of the optical waveguide, a thin film approximately 0.2 to 0.4 μm thick is suitable for a beam the wavelength of which is 1.55 μm. As the structure of the optical waveguide is also unchanged in a position in which the beam is input to the optical waveguide 501, the sectional structure on the cross-section A′ shown in FIG. 1 is shown in FIG. 6. As known from FIGS. 5 and 6, the width and the height of a ridge forming the optical waveguide 501 are unchanged in a propagational direction of the beam.

Next, a problem of a Mach-Zehnder interferometer using such a thin film will be described. In a conventional type method, in case the sectional form and size (hereinafter, optical intensity distribution on a cross-section perpendicular to a propagational direction of the beam is called a beam spot. The size of the beam spot means width at a half maximum at which intensity is a half for the maximum value of optical intensity) of a beam via the lens and the fiber from the laser source 16 are not coincident with the form and size of a beam spot propagated in the optical waveguide 501 when the beam from the external laser source 16 shown in FIG. 1 is incident on the optical waveguide 501 formed on the substrate 200, a part of the input beam leaks without being input to the optical waveguide 501. As the difference in the form and the size between beam spots grows up, the intensity of a leaked beam is increased.

As the optical waveguide 516, the optical waveguide 517 and the optical waveguide 501 respectively shown in FIG. 1 are simultaneously formed by etching, the thickness of a core layer the optical waveguide 501, 516 and 517 shown in FIG. 5 or 6 has the same value. As shown later, to convert a response of a refractive index by the adsorption of a target compound in a specific receptor to a phase response efficiently, an optical waveguide having thin film structure is desirable. Therefore, a spot of the beam propagated in the optical waveguide 501 is approximately 0.3 to 0.6 μm as shown by x in FIGS. 5 and 6 in a direction of the thickness of the substrate and is very small. In the meantime, the spot diameter of a light beam output from the fiber is approximately 10 μm and is large. Therefore, coupling efficiency from the optical fiber to the optical waveguide 501 is 10% or less and most light leaks. When the beam from the laser source 16 having a wavelength of 1.55 μm is input to the optical waveguide 501 using the lens, spot size in the waveguide is 0.3 to 0.6 μm and is smaller, compared with approximately 0.8 μm which is a limit value of a spot diameter which can be reduced by the lens. Therefore, in the case of coupling using the lens, a strong leak by the non-conformance of spot size is caused.

It has been described that because of difference between the spot form and size of the beam propagated in the optical waveguide and the spot form and size of the beam from the external laser source, the beam from the laser source 16 cannot be efficiently input to the optical waveguide 501. Next, a problem caused when a strong leak is caused without being efficiently input to the optical waveguide 501 will be described.

A beam which is not input to the optical waveguide 501 out of beams from the laser source 16 in FIG. 1 passes the inside of the substrate 200 and the vicinity of the surface of the substrate, interferes and is mixed with the beam via the optical waveguide 516 and the optical waveguide 517 from the optical waveguide 501 and optical intensity measured by the photodetector 40 varies independent of the adsorption of a target compound. At this time, it is particularly a problem that the phase and the intensity of the beam passing the inside of the substrate 200 and the vicinity of the surface of the substrate 200 easily vary by the change of temperature outside the chemical sensor and a response of the refractive index by the change of the flow of a target compound. Thereby, when such beams interfere and are mixed with the beams propagated in the proper optical waveguides 516, 517, the unintended fluctuation of intensity is caused and a phase response by the adsorption of a small quantity of a target compound cannot be observed. That is, the deterioration of coupling efficiency to the optical waveguide 501 causes the deterioration of the measuring sensitivity of a target compound.

A beam from the substrate 200 (hereinafter called a sensor chip) on which a Mach-Zehnder optical waveguide is formed is also required to be efficiently input to the photodetector 40. That is, to efficiently lead the beam propagated in the optical waveguides 516, 517 and multiplexed in the optical waveguide 502 to the fiber and the photodetector via the optical coupling means 702 shown in FIG. 1, spot size is required to be regulated. The reason is that as also in this case, the beam cannot be efficiently input to the fiber and the photodetector when the optical waveguide 502 is thin, and the intensity of the beam observed in the photodetector varies because of another cause except the adsorption of a target compound. For example, when a leaked beam is reflected on the surface of the optical coupling means 702, is reflected again on the surface of the optical coupling means 701 and the beam is input to the fiber and the photodetector, the fluctuation of optical intensity is caused as described above. A beam may be also reflected at other many points.

Next, referring to FIG. 7, it will be described why thin film structure is suitable to efficiently convert a response of the refractive index by the adsorption of a target compound in a specific receptor to a phase response. The abscissa Y of FIG. 7 corresponds to difference between the normalized refractive indexes of thin cores for the clad substrate 200 which is v(ns²−nc²)/nc (ns denotes the refractive index of the thin core of the optical waveguides 516, 517 shown in FIG. 4 and nc denotes the refractive index of the clad substrate 200 (the substrate and a cladding layer are the same in FIG. 4)) and the ordinate shows the thickness of the thin cores.

The ratio (the larger the ratio is, the higher efficiency is) of a phase response to a change of the refractive index by the adsorption of a target compound is represented by varying the two parameters in a plane and differentiating in color. In FIG. 7, the thinner the color is, the higher conversion efficiency is. As understood from FIG. 7, if the refractive index of a thin film is suitably selected, the efficiency is higher when the film is thinner (for example, Y=0.3). However, as the propagation of a beam is disabled when the thin core forming the optical waveguide is too thin, the thickness of approximately 0.2 to 0.4 μm is optimum in case the refractive index of the thin film is 1.7 and the refractive index of the cladding layer on the side of the substrate 200 is 1.52. Therefore, a spot of the beam propagated in the optical waveguide is 0.3 to 0.6 μm in a direction perpendicular to the substrate.

In case the absorbed amount of the beam propagated in the optical waveguide is measured, a Mach-Zehnder interferometer has only to be replaced with an optical waveguide. That is, in the optical waveguide in which the specific receptor is immobilized and in the reference optical waveguide in which no specific receptor is immobilized, a leaked beam except the beam propagated in the optical waveguide is mixed and interferes with each output beam, and optical intensity fluctuates. Therefore, the deterioration of sensitivity is caused. It is similar to Mach-Zehnder type that a beam causing unintended fluctuation is also caused when a point at which the beam is reflected is inserted on the way of the optical waveguide.

### SUMMARY OF THE INVENTION

To improve the above-mentioned problems, in a chemical sensor chip having configuration that a beam from a laser source is input to an optical waveguide configured on a substrate from an end face of the substrate, the leakage of the incident beam from the optical waveguide is inhibited by providing structure that the sectional form of a part (this part is called a core layer) in which a refractive index is made higher than that in the periphery to confine the beam in the optical waveguide sufficiently slowly changes toward the inside from the end face of the substrate, compared with a wavelength. The configuration will be concretely described below. The sufficiently slow change, compared with the wavelength means that the structure of the same optical waveguide, that is, the width and the thickness change by only the same extent as the wavelength or smaller while the beam advances by distance equivalent to 10 times or more of the wavelength in a direction in which the beam is propagated.

A concrete example is as follows. In a chemical sensing chip provided with a Mach-Zehnder interferometer formed on the substrate, a part of an input optical waveguide or an output optical waveguide is tapered (hereby, a spot form of a light beam from a fiber and others is converted from a form close to a circle to an ellipse the aspect ratio of which is large or is converted from an ellipse to a form close to a circle). Or the chemical sensing chip is configured so that the thickness or the width of at least one of optical waveguides composed of Mach-Zehnder interferometer is tapered. In place of a taper of at least a part of the input/output waveguides, the width or the thickness of the waveguide in a part close to the Y-type branchpoint of the waveguide forming the interferometer is relatively reduced and the width or the thickness of the waveguide in the center of the waveguide is relatively increased. Hereby, in the waveguide close to the Y-type branchpoint, a spot form of a light beam is close to a circle and in the center, the spot form changes to an ellipse the aspect ratio of which is large.

The configuration will be described concretely below.

Means 505, 511 for realizing a spot size conversion function are arranged in input/output parts to/from an optical waveguide on a substrate 200 of a Mach-Zehnder chemical sensor chip shown in FIG. 8. A beam from a laser source 10 is led to the optical waveguide 505 provided with the spot size conversion function on the substrate 200 by optical coupling means 20 such as a lens and an arrayed fiber, is uniformly branched in two at a Y-type branchpoint 100 and the interferometer is configured. The optical waveguide 505 provided with the spot size conversion function is characterized in that the width and the thickness of the optical waveguide are tapered in the traveling direction of the beam. The change is required to be sufficiently slow. Afterward, the beam is propagated in an optical waveguide 501 shown in FIG. 8 in which a specific receptor is immobilized as in the conventional type and an optical waveguide 502 in which no specific receptor is immobilized. At this time, a phase of the beam propagated in the optical waveguide 501 shown in FIG. 8 greatly varies by the absorption of a target compound in the specific receptor, compared with a phase of the beam propagated in the optical waveguide 502 and phase difference is made between the beams propagated in both. Next, as these beams are multiplexed and made to interfere at a Y-type branchpoint 110, optical intensity varies depending upon the adsorption of the target compound. The adsorbed amount of the target compound is measured by measuring the variation of the optical intensity. That is, the beam is converted to an electric signal in a photodetector 40 from the optical waveguide 511 provided with the spot size conversion function via optical coupling means 30 such as a lens and an arrayed fiber.

FIG. 40 is a top view in case in place of a taper of at least a part of the input/output waveguides, the width or the thickness of the waveguide close to the Y-type branchpoint of the waveguide forming an interferometer is relatively reduced and the width or the thickness of the waveguide in the center is relatively increased. FIG. 40 is different from FIG. 8 in that the input/output waveguides 505, 511 are not tapered and the width and the thickness of the optical waveguide are unchanged. In the meantime, an optical waveguide 531 shown in FIG. 40 is tapered and the width or the thickness of the optical waveguide 501 is larger than the width or the thickness of the optical waveguides 505, 511. Hereby, optical spot size is extended in the input/output parts and the loss of light in the optical coupling means can be reduced.

Next, referring to FIG. 26, the configuration of the whole chemical sensor will be described. First, a solvent including no target compound and stored in 1170 for comparison such as deionized water is made to flow into a reaction chamber 305.

The flow is controlled via a flow controller 1150 from a measurement controller 1010. At this time, the laser source 10 is connected to the optical waveguide substrate 200. The output of photodetectors 40, 41 is input to an output signal processor 1000 corresponding to ambient temperature and others. Movement to an operating point shown in FIG. 16 is made by sending a signal to a wavelength controller 1110 for controlling the wavelength of the laser source 10 so that (PD1−PD2)/(PD1+PD2) is 0 and changing a wavelength. Next, the flow controller switches to flow from measured environment and leads a target compound 602 into the reaction chamber 305. At this time, the wavelength of the laser source 10 remains constant. According to the concentration of the target compound, (PD1−PD2)/(PD1+PD2) varies. This output signal is sent to the measurement controller 1010 and output including the concentration of the target compound is transmitted to a display 1200 and another terminal 1300 on a network, referring to data for converting measurement data acquired by calibration to the concentration of the target compound. In measurement, the wavelength of the laser source is constant, however, for the further enhancement of sensitivity, the wavelength of the laser source 10 is controlled so that (PD1−PD2)/(PD1+PD2) is 0, a signal to the wavelength controller 1110 is converted to a target compound and a chemical can be also sensed.

Next, referring to FIG. 11, the structure of the optical waveguide 505 and the optical waveguide 511 which is particularly simple structure for realizing the spot size conversion function and the manufacture of which is easy will be described. FIG. 9 is a sectional view corresponding to a cross-section E shown in FIG. 6 and corresponding to a hidden inside face in FIG. 11. FIG. 6 corresponds to a cross-section D and FIG. 10 is a sectional view corresponding to a front face shown in FIG. 11. FIG. 12 is a sectional view showing the basic structure of the optical waveguide including the sensor in which the target compound 602 is adsorbed in the specific receptor 601 and the sectional structure is viewed along a cross-section E shown in FIG. 8. That is, it is the same as the sectional structure shown in FIG. 9. The spot size conversion function is realized by structure in which the width of a thin first core layer 505 is narrowed toward the end face of the substrate (toward the front in FIG. 1) as shown in FIG. 11. That is, tapered structure that the first core layer 505 is gradually narrowed toward the end face of the substrate 200 from a form shown in FIG. 9 has sectional structure shown in FIG. 10 on the end face of the substrate.

The basic structure (including the sensor) of the optical waveguide shown in FIG. 9 is as follows. A cladding layer 250 the refractive index of which is lower than a thin core layer is arranged between the first thin core layer 505 the refractive index of which is the highest and the substrate 200 (in case the refractive index of the substrate is lower than that of the first thin core layer and an optical absorption coefficient is small, the substrate 200 can be also used in place of the cladding layer 250) and further, a second core layer 300 the refractive index of which is lower than that of the first core layer 505 and the refractive index of which is higher than that of the cladding layer is provided between the cladding layer 250 and the first thin core layer 505. The sectional view shown in FIG. 9 corresponds to a cross-section E for example in the top view shown in FIG. 8 and corresponds to the cross-section in a position sufficiently apart from the end face of the substrate. In the sectional structure, an optical spot 510 is substantially confined in the first core layer and spot size is small and flat.

In the meantime, FIG. 10 corresponds to a cross-section D in the vicinity of a point 21 at which a beam from means 20 for leading a beam from a laser source into a waveguide is first led to the substrate. The width 310 of the first core layer 505 is narrowed so that the optical spot size 510 on the cross-section D shown in FIG. 10 grows. That is, beam confinement effect in the layer 505 is weakened by narrowing the width 310, confinement effect in the second core layer 300 is relatively enhanced, structure in which the first core layer 505 and the second core layer 300 are combined is made to function as the core layers (beam confinement layers) and the optical spot size is enlarged. The thickness of the second core layer 300 is set to a suitable value, the spot 510 shown in FIG. 10 is fitted to an optical spot in an optical fiber from a lens, and efficient optical coupling is realized.

FIG. 12 shows the sectional structure of the sensor. The basic structure of the waveguides is similar to that shown in FIG. 9. The specific receptor 601 that selectively adsorbs the target compound 602 is immobilized in the area 400 of the waveguide 502 on one of the waveguides. In the meantime, in the area 401 of the waveguide 501, no specific receptor is immobilized and the waveguide 501 functions as the reference of a phase response and a waveguide.

To explain a method of enlarging a spot in the above-mentioned structure further detailedly, it is as follows. To enhance the efficiency of a phase response by the adsorption of the target compound, the thickness 312 shown in FIG. 10 of the first core layer forming a waveguide is set to 0.2 to 0.4 μm and is thin, and the refractive index of the cladding layer 250 is set to a suitable value of 10% or more. The thickness 313 of the second core layer 300 is approximately a few μm and is thick, further, the optical spot 510 can greatly stick out into the cladding layer 250 by setting difference in a refractive index with the cladding layer to a smaller value than 0.4%, and a spot form can approach a circle. Hereby, the spot form can be fitted to a spot form from the optical fiber and the lens. As the refractive index of the second core layer 300 is made close to the refractive index of the cladding layer 250 (0.4% or less), the spot 510 in the sensor is substantially confined in the first core layer 505 and it is effective to enhance the efficiency of a phase response by the absorption of the target compound.

Besides, the form and the size of the spot can be controlled only by varying and controlling the width of the first core layer 505 in the substrate in this structure. The in-plane control of the width of the thin-film structure can be realized easily and precisely using semiconductor lithography technology. Therefore, precise control over the spot size and the spot form in the sectional view in FIG. 10 can be realized by a simple production method.

Next, a case that the intensity of a measurement beam fluctuates by the mixture of light except a leaked beam in input will be described and next, a measure for solution will be described.

FIG. 13 is a sectional view viewed along an optical waveguide of a sensor chip in which the intensity of a measurement beam may fluctuate by the mixture of light except a leaked beam. A thin core layer 505 is formed on a cladding layer 250 on a substrate 200 and receptors 601 are immobilized in a part of the core layer. An upper cladding layer 506 which also functions as a protective layer is formed in areas including optical input/output layers.

At this time, spot size can be enlarged by bringing the refractive index of the upper cladding layer 506 close to the refractive index of the core layer 505, however, as the refractive index of a solvent (water and air) including a target compound is low in an area including an area in which receptors are immobilized (the refractive index of water is 1.333 and that of air is 1.0), the refractive index of the upper cladding layer necessarily increases and a beam is reflected at points 22 and 23. Hereby, not only a beam directly output from an input point to an output point via the points 22, 23 without returning the waveguide is observed but a beam to which multipath reflection is applied from the input point to the output point via the point 22, the point 23, the point 22, the point 23 and the point 22 is observed with the beam interfering with the direct beam. An optical path length of such a beam to which multipath reflection is applied greatly varies by the temperature of the solvent and the fluctuation of the density. Therefore, optical intensity after interference fluctuates.

A method of removing such multipath reflection is realized by adopting tapered structure in the thickness of the upper cladding layer 506 as shown in FIG. 14.

However, as the optical spot form becomes asymmetrical when a higher refractive index than that of the cladding layer 250 is given to the upper cladding layer 506, displacement with an optical spot of a symmetrical optical fiber cannot be completely solved, for spot size, 2 to 3 μm are also a limit and the optical spot is not completely coincident with the spot of the fiber in size.

However, in case a sensor chip is configured without providing the upper cladding layer in the vicinity of the optical coupling means as described above, the problem of multipath reflection is not caused.

It need scarcely be said that the rate of multipath reflection can be reduced by inserting the second core layer 300 in addition to the first core layer 505 as in the measure for solution and narrowing the width of the layer 505 at the points 22, 23 shown in FIG. 13.

Needless to say, it is further desirable to use both of the measure for solution of providing the first core layer and the second core layer and the tapered structure of the upper cladding layer 506.

Next, a method of enhancing the input efficiency of a beam from the sensor chip to the photodetector will be described. As shown in FIG. 15, a beam propagated in the optical waveguides 501, 502 is multiplexed and demultiplexed in a directional coupler 111 and is made to interfere. As a result, intensity propagated in the waveguides 511, 512 and measured in the photodetectors 40, 41 via the optical coupling means 30, 31 varies as shown in FIG. 16 depending upon phase difference between beams propagated in the optical waveguides 501, 502. In FIG. 16, the abscissa shows the phase difference and the ordinate shows optical intensity, that is, optical intensity measured by PD1 (corresponding to the photodetector 40) or PD2 (corresponding to the photodetector 41). It should be noted that the sum of the intensity of PD1 (corresponding to the photodetector 40) and PD2 (corresponding to the photodetector 41) is constant under any phase condition. Therefore, when beams are multiplexed and demultiplexed by phase difference in the directional coupler in principle, the beams are never leaked except the waveguides. Therefore, it can be inhibited that a leaked beam is reflected on multipath and the fluctuation of optical intensity is increased.

Finally, a method of changing the waveguide structure of the sensor and further enhancing sensitivity (enhancing phase response conversion efficiency by the adsorption of a target compound) will be described. In the measure for solution, concerning the waveguide structure of the sensor, a beam is confined in the first thin core layer 505 and the receptors for adsorbing the target compound are immobilized on only the top face of the first thin core layer 505 as shown in FIG. 9. further, to increase the overlap of the receptor and the beam, as the degree of the sticking out of the beam is equal to that of the thin film by narrowing the width so that the width is 0.5 μm or less as shown in FIG. 17 and a double receptor immobilization area can be secured, sensitivity can be enhanced by approximately double. FIG. 18 is a sectional view viewed in the vicinity of an area on which the beam is incident. A spot having the similar size to that of the fiber can be acquired by widening the width of the core layer 505, providing the upper cladding layer and bringing the refractive index close to that of the core layer 505. It need scarcely be said that FIG. 15 and sectional structure shown in FIG. 14 are smoothly connected via tapered structure.

In case a response of the optical absorption coefficient is measured, a leaked beam is reduced by adopting tapered structure in the input/output optical waveguides and the fluctuation of the output beam can be inhibited. The sectional view of the beam input part is shown in FIGS. 9, 10, 11 and is the same as the sectional view of the Mach-Zehnder type input part. A leaked beam is inhibited by adopting such tapered structure and optical fluctuation can be reduced. FIG. 34 is a top view. FIG. 34 is different from the Mach-Zehnder type shown in FIG. 15 in that in FIG. 34, one optical waveguide is branched into two optical waveguides 518, 519 and they are connected to output optical waveguides 511, 512 without being multiplexed afterward. Specific receptors are immobilized in an area 400 on the optical waveguide 518 and a target compound or a complex of the target compound and a marker can be adsorbed. In the meantime, no specific receptor is immobilized in an area 401 on the optical waveguide 519 or specific receptors that selectively adsorb a substance except the target compound are immobilized. Therefore, difference between optical intensity output from the optical waveguide 511 by the adsorption of the target compound and optical intensity output from the optical waveguide 512 increases, the difference in intensity is converted to the adsorbed amount of the target compound and the target compound is sensed. It need scarcely be said that the similar effect to the Mach-Zehnder type can be expected by inhibiting multipath reflection and also immobilizing specific receptors on the sides of the waveguide.

### BRIEF DESCRIPTION OF THE DRAWINGS

FIG. 1 is a top view showing a well-known chemical sensor;

FIG. 2 is a sectional view viewed along a cross-section A and showing the well-known chemical sensor;

FIG. 3 shows relation between the output of a Mach-Zehnder interferometer (one output) equivalent to an embodiment of the invention and phase difference;

FIG. 4 is a sectional view viewed along the cross-section A in FIG. 1 and showing a thin core layer;

FIG. 5 is a sectional view viewed along a cross-section A′ in FIG. 1 and showing the thin core layer;

FIG. 6 is a sectional view showing a well-known example in case a thin-film waveguide is used;

FIG. 7 is a graph showing relation in efficiency in converting the thickness of the thin film and a response of a refractive index to a phase response;

FIG. 8 is a top view showing a Mach-Zehnder interferometer-type chemical sensor according to the invention (one output);

FIG. 9 is a sectional view showing a waveguide except the vicinity of an end face according to the invention (basic waveguide structure);

FIG. 10 is a sectional view showing a waveguide in the vicinity of the end face according to the invention;

FIG. 11 is a top view showing the waveguide in the vicinity of the end face according to the invention;

FIG. 12 is a sectional view showing the sensor according to the invention;

FIG. 13 is an explanatory drawing for explaining multipath reflection;

FIG. 14 shows configuration in which the multipath reflection is inhibited;

FIG. 15 is a top view showing a case of two outputs according to the invention;

FIG. 16 shows relation between the output of a Mach-Zehnder interferometer (two outputs) and phase difference;

FIG. 17 is a sectional view showing the sensor having configuration that sensitivity is enhanced using a narrow waveguide;

FIG. 18 is a sectional view showing the end face of the configuration that sensitivity is enhanced using the narrow waveguide;

FIG. 19 is a top view showing a Mach-Zehnder interferometer-type chemical sensor equivalent to a first-embodiment;

FIG. 20 shows an arrayed fiber of one output;

FIG. 21 shows an arrayed fiber of two outputs;

FIG. 22 is a sectional view corresponding to a cross-section D shown in FIG. 16;

FIG. 23 is a sectional view corresponding to a cross-section E shown in FIG. 16;

FIG. 24 is a sectional view corresponding to a cross-section C shown in FIG. 16;

FIG. 25 is a sectional view corresponding to a cross-section B shown in FIG. 16;

FIG. 26 is a block diagram showing a system in the first embodiment;

FIG. 27 is a sectional view corresponding to a cross-section B shown in FIG. 19 equivalent to a third embodiment;

FIG. 28 is a top view showing a Mach-Zehnder interferometer-type chemical sensor corresponding to a fourth embodiment;

FIG. 29 is a sectional view corresponding to a cross-section C shown in FIG. 28 in the fourth embodiment;

FIG. 30 is a sectional view corresponding to a cross-section D shown in FIG. 28 in the fourth embodiment;

FIG. 31 is a top view showing a conventional type absorption-type chemical sensor;

FIG. 32 is a sectional view corresponding to a cross-section A shown in FIG. 31;

FIG. 33 is a sectional view corresponding to a cross-section A′ shown in FIG. 31;

FIG. 34 is a top view showing an absorption-type chemical sensor according to the invention;

FIG. 35 is a sectional view showing a sensor equivalent to a second embodiment (corresponding to a cross-section C shown in FIG. 36);

FIG. 36 is a top view showing a Mach-Zehnder interferometer-type chemical sensor in the second embodiment;

FIG. 37 is a sectional view corresponding to a cross-section D shown in FIG. 36 in the second embodiment;

FIG. 38 is a sectional view corresponding to a cross-section E shown in FIG. 36 in the second embodiment;

FIG. 39 is a top view showing an absorption-type chemical sensor equivalent to a fifth embodiment; and

FIG. 40 is a top view in case parts close to a Y-type branchpoint of waveguides forming an interferometer are tapered.

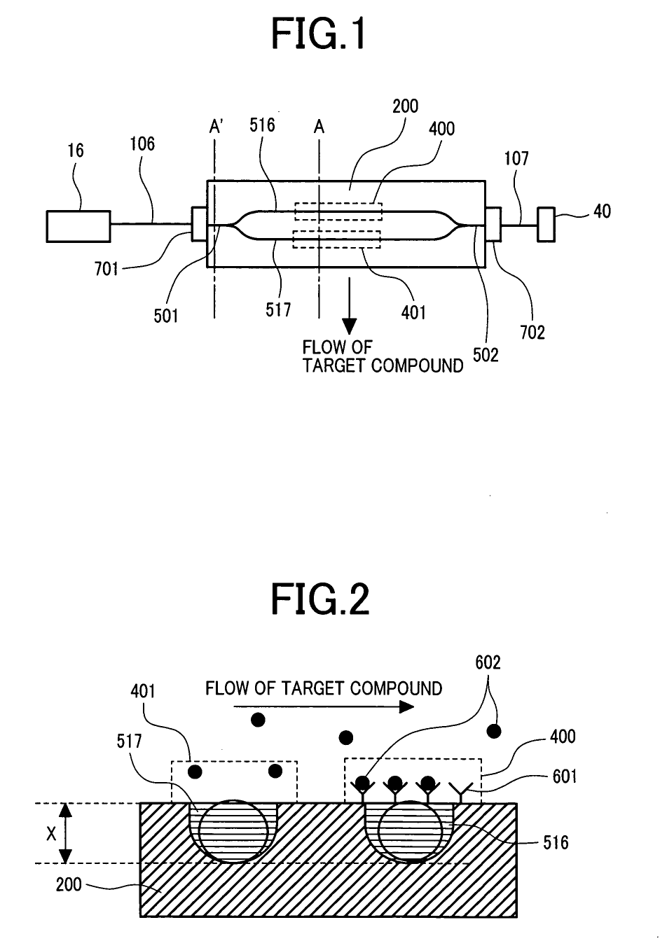

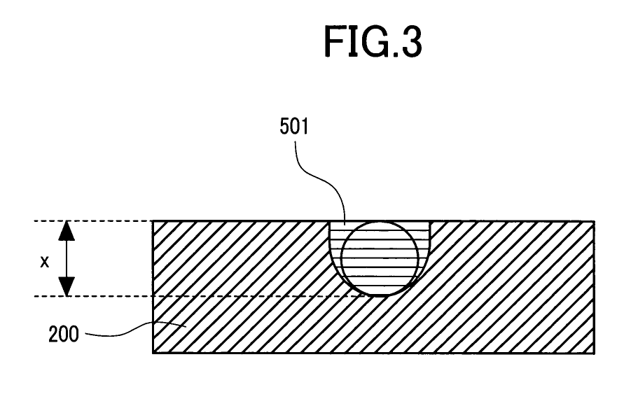

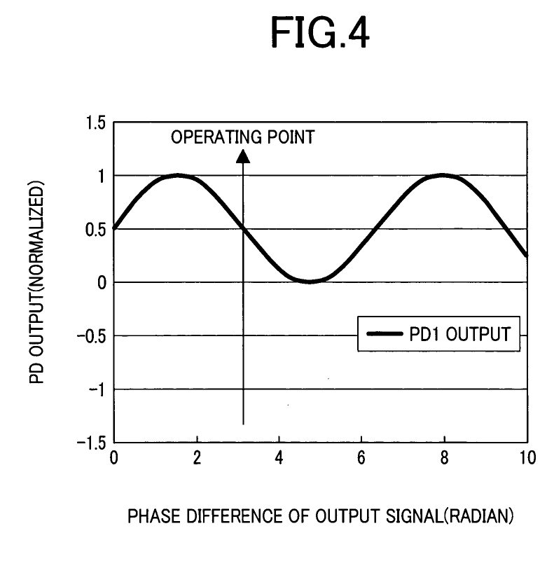

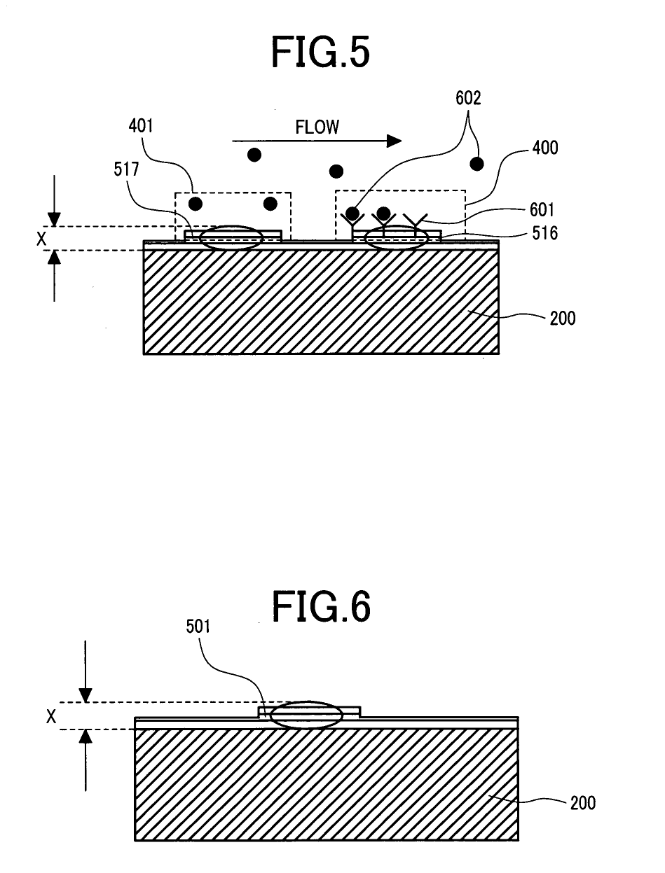

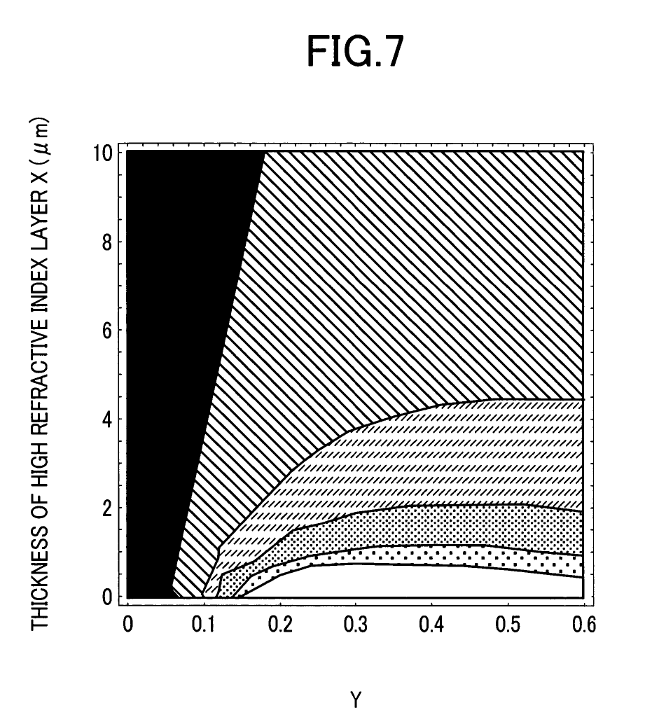

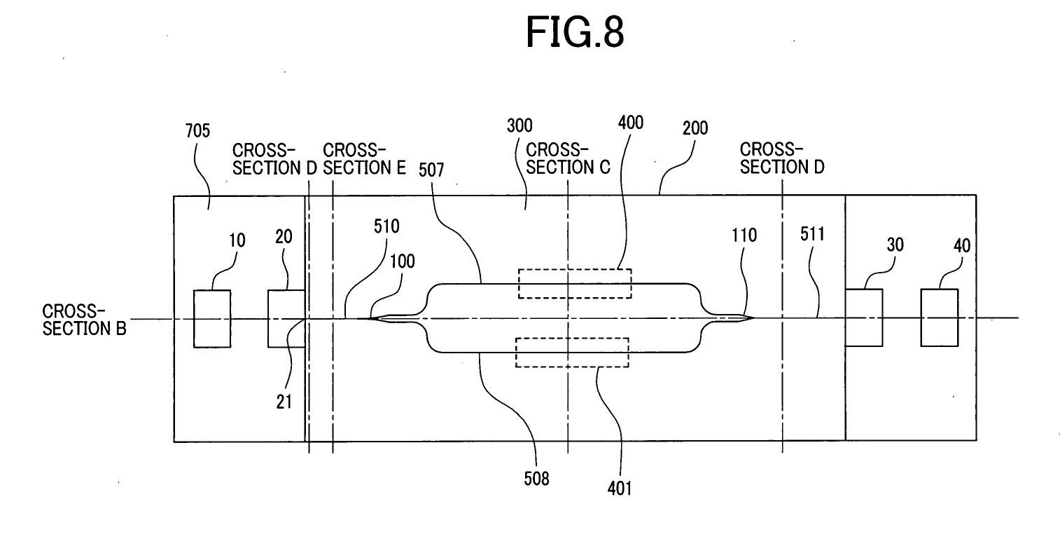

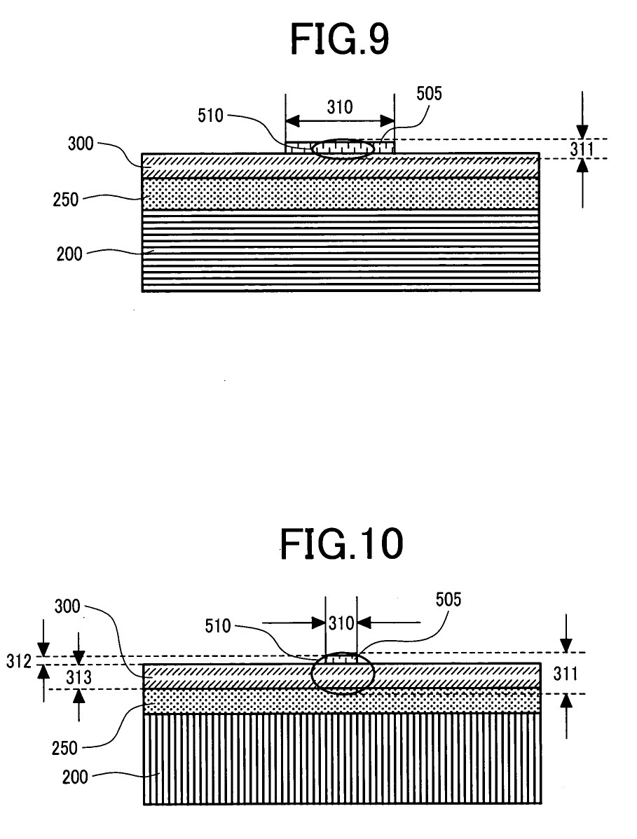

### DETAILED DESCRIPTION OF THE PREFERRED EMBODIMENTS

First Embodiment

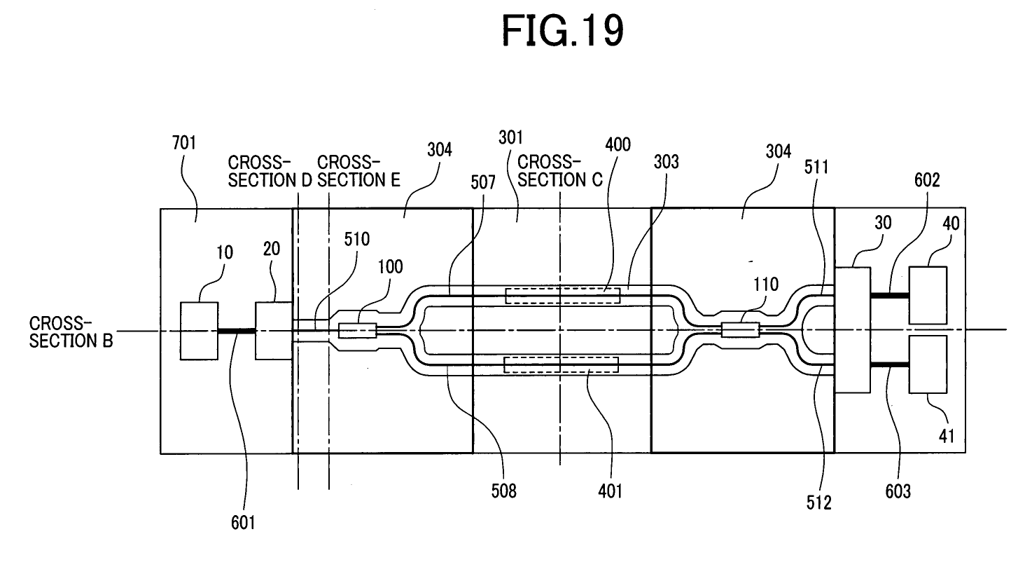

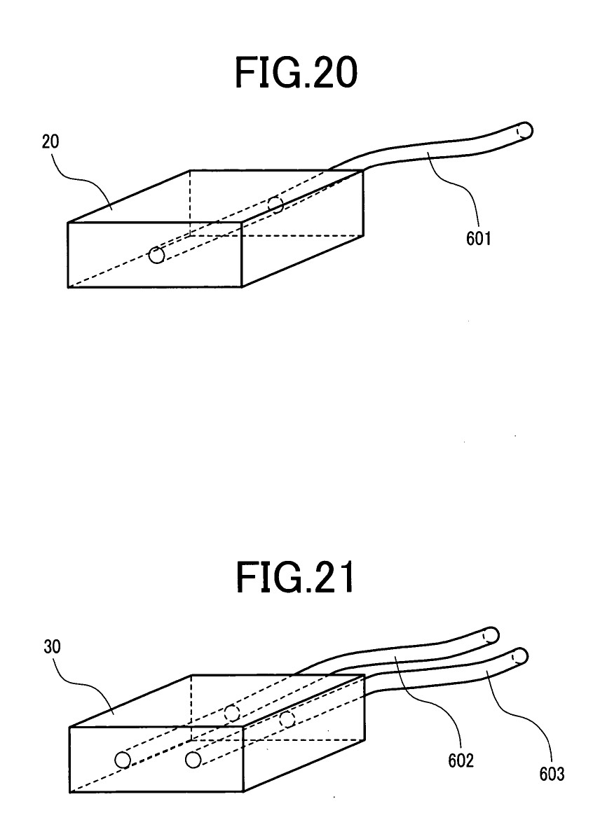

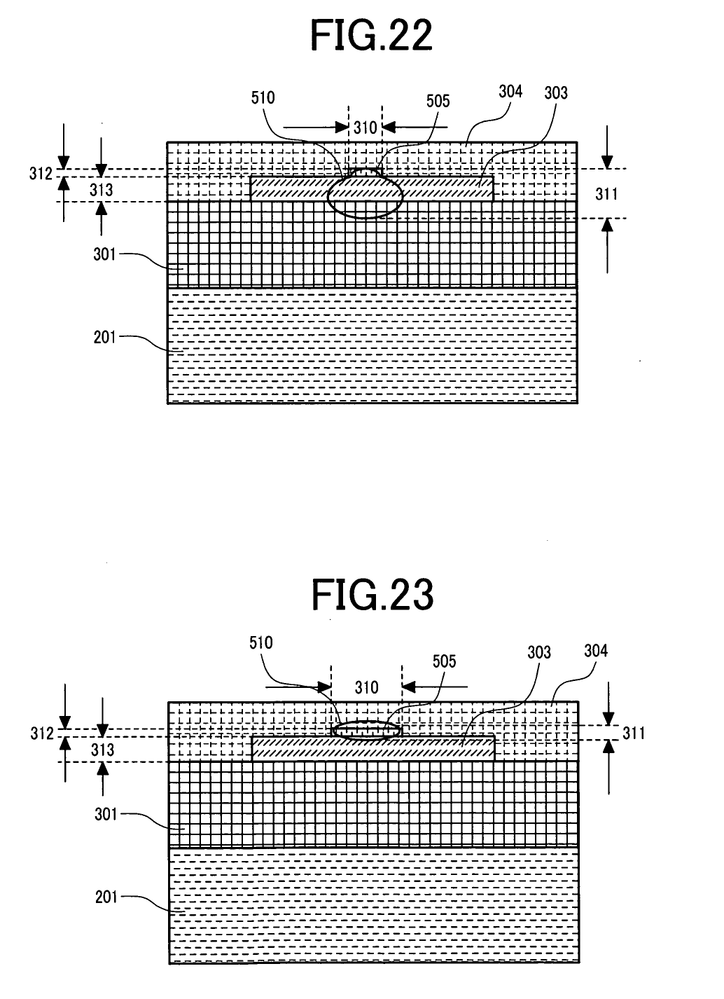

Referring to FIG. 19, the configuration of a sensor equivalent to a first embodiment of the invention will be described below. A silicon substrate 200 having the thickness of 1 μm and forming an optical waveguide is fixed onto a submounted chip carrier 701 made of copper having high thermal conductivity. A laser beam from a distributed feedback (DFB) laser 10 is input to a waveguide provided with a spot conversion function 505 via a fiber 601 and an arrayed fiber (20 in FIG. 20) which is optically coupling means. The waveguide provided with the spot conversion function is tapered in a direction parallel to the substrate. FIG. 22 shows a cross-section D close to the end face of the substrate and FIG. 23 shows a cross-section E farther from the end face than the cross-section D. The width of the waveguide 505 on the cross-section D is narrower than that on the cross-section E. That is, when 310 (6 μm) in FIG. 23 and 310 (3.8 μm) in FIG. 22 are compared, 310 in FIG. 22 is set so that it is narrower. Hereby, the shape 510 of an optical spot of the waveguide having the same width as that of the sensor is elliptic as shown in FIG. 23, the height 311 perpendicular to the substrate of the optical spot is approximately 0.6 μm and is short, however, the spot size 311 is relatively close to a circle in the vicinity of the end face, can be made approximately 8 μm, and satisfactory optical coupling with the fiber in the arrayed fiber 20 can be realized. The beam is branched in two in a multimode interferometer (MMI) 100. MMI for branching is 310 mm long and is 20 μm in width. The basic structure of each cross-section of MMI and the sensor is the same. The reason why the basic structure is the same is that a stable characteristic of the waveguide can be acquired without depending upon etching because a first core layer is completely etched and the width (the spot size) of the optical waveguide is determined depending upon the width of the first core layer 505. If only a part of a core layer is etched as in the conventional type waveguide utilizing a thin film, a characteristic of the waveguide varies and the optimum length and width of MMI vary respectively depending upon an etched amount. As this causes the leakage of a beam, the sensitivity is deteriorated. Therefore, the completely branched beam is propagated in a waveguide 501 having the length of 15000 μm and a waveguide 502 having the length of 15080 μm.

The width of each waveguide is set to 6 μm. The waveguide 501 passes an area 400 in which receptors are immobilized and the phase varies depending upon the adsorption of a target compound. As the waveguides 501 and 502 are different by 80 μm in length, phase difference between both can be regulated by differentiating wavelengths. The phase difference of 2 p can be made by the difference between the wavelengths of 20 nm. For a multiplexer, MMI having two input terminals and two output terminals is used, the length is 395 μm and the width is 14.5 μm. The beam branched in two is measured by a two-channel arrayed fiber 30 via waveguides provided with a spot conversion function 511, 512 and by photodetectors 40, 41 via optical fibers 602, 603. FIG. 21 shows the two-channel arrayed fiber. Hereby, excess loss can be inhibited so that it is 1 dB or less.

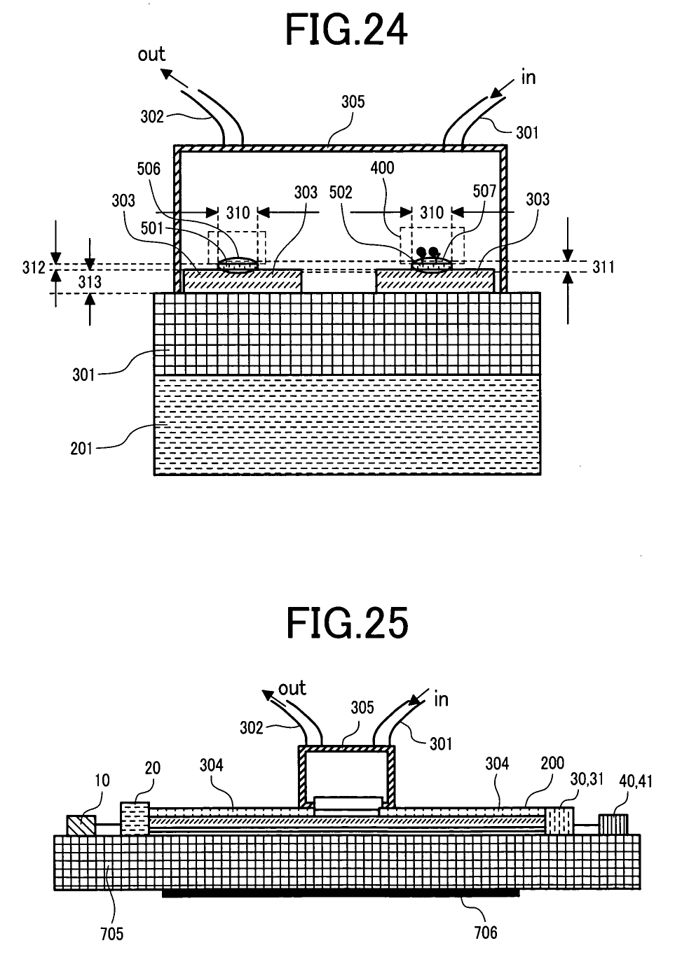

Next, a method of forming will be described. FIG. 24 is a sectional view viewed along a cross-section C shown in FIG. 19. A thermosetting polymer (refractive index: 1.5) is applied by 15 μm so as to form a Mach-Zehnder interferometer on a silicon substrate 200 having the thickness of 1 mm and a cladding layer 301 is formed. A layer 313 to be a second core 300 of the optical waveguide is applied onto the input/output part of the cladding layer by 4.0 μm and is hardened. Layers 501, 502 to be a first core of the optical waveguide in the sensor are similarly made of a thermosetting polymer (refractive index: 1.8) having the thickness of 0.3 μm. It need scarcely be said that for the material, SiN, ZiO and TiO may be also used. At this time, to form the waveguide, a photoresist pattern having the shape of the waveguide is formed after the application, only the core layers are patterned by reactive ion etching (dry etching) to be the sensor 6 μm wide and the width in the vicinity of the end face of the substrate of the waveguide is set to 3.8 μm. Next, the layer 303 is etched by 40 μm in width by the similar reactive ion etching and as shown by 303 in FIG. 19, the layer surrounds the waveguides 501, 502, 505, 511, 512 and inhibits the diffusion of a leaked beam.

Besides, the waveguide is covered with a protective film made of PDMS as shown in FIG. 22 corresponding to the cross-section D and in FIG. 20 corresponding to the cross-section E. Hereby, when a reaction chamber shown in FIG. 25 is detached, a stable optical signal can be also acquired.

Next, to immobilize an anti-dioxin monoclonal antibody also used in immunoassay for sensing dioxin in solution in the area 400, silane coupling agents are applied to the area 400 using photoresist. Afterward, the substrate 200 is dipped in a buffer including the antibody and the anti-dioxin monoclonal antibody is immobilized in the area 400. In case a target compound is changed to another chemical, it need scarcely be said that the corresponding antibody is immobilized in the area 400. Further, to enhance sensitivity, a second antibody combined to the immobilized antibody together with the target compound can be also used. Further, in this embodiment, nothing is immobilized in an area 401, however, it need scarcely be said that the accuracy of measurement can be enhanced by immobilizing another antibody competitive with the antibody immobilized in the area 400 in this area 401. It need scarcely be said that a phenomenon that the structure of a specific receptor varies when dioxin which is the target compound is adsorbed and a refractive index varies in the wavelength of the incident beam can be utilized.

The layers forming the first core layers of the waveguides 501, 502 in FIG. 24 showing the cross-section of the sensor are made of material having a strong birefringent characteristic. Therefore, the optical waveguides 501, 502 structurally having the effect are also provided with a strong birefringent characteristic. Hereby, a transverse electric (TE) polarized beam and a transverse magnetic (TM) polarized beam are different in the manner of leakage and even if an amount of the adsorbed target compound is the same, the beams are different in a phase response. Conversely, the distribution in a direction of the cross-section of the target compound can be known utilizing this.

As described above, in this embodiment, the arrayed fibers 20, 30 are used for optical coupling means from the laser 10 to the optical waveguide 505 and from the optical waveguides 511, 512 to the photodetectors 40, 41. The reference numbers 601 to 603 denote the optical fiber. The reference number 10 denotes the distributed feedback laser diode, the waveband of the distributed feedback laser diode is 1.55 μm and the distributed feedback laser diode can control the wavelength of the beam output with the temperature of the laser diode varied by a peltier cooler. For a light receiving element, the photodetector including InGaAs in an absorptive layer is used and to minimize dispersion in the sensitivity of two photodetectors, surface mount detectors the thickness of each absorptive layer of which is 1 μm or more are used. The light source, the substrate 200 and the photodetectors are arranged on a base 705 made of copper and having high thermal conductivity and the temperature of the base 705 is controlled by the peltier cooler 706. Hereby, the temperature of the substrate is kept constant.

Next, a flow system for target compounds will be described. A reaction chamber 305 is a box made of Teflon (a trademark) and is mounted on the substrate 200 as shown in FIGS. 24 and 25. FIG. 25 is a sectional view viewed along a cross-section B in FIG. 19. A reference number 301 denotes a tube for leading solution including target compounds into the reaction chamber 305 and 302 denotes a tube for exhausting the solution. A reference number 706 denotes a peltier cooler for controlling temperature.

Besides, according to the invention, the concentration of a chemical to be continuously sensed can be measured by making liquid or gas in which the chemical to be sensed is mixed continuously flow from the tube 301 to the tube 302 via the reaction chamber 305. However, to achieve the object, the temperature is required to be kept constant using the peltier cooler 706 so as to keep an equilibrium state between the target compound 602 and the specific receptor 601 (for example, an antibody against 602 as an antigen) constant.

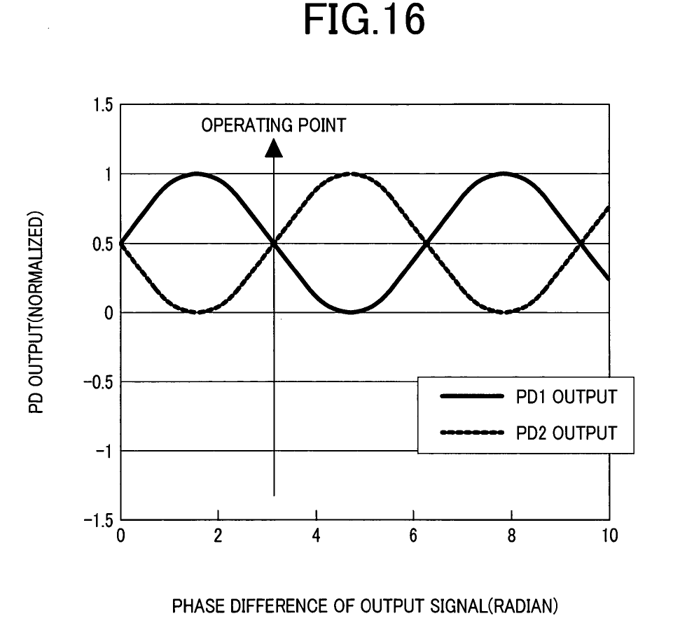

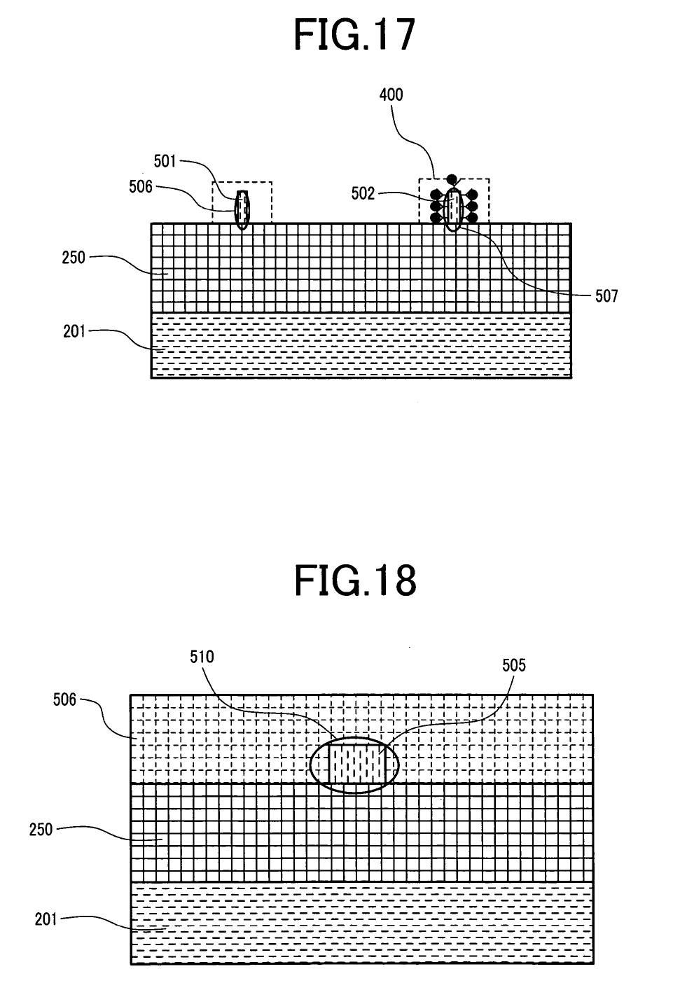

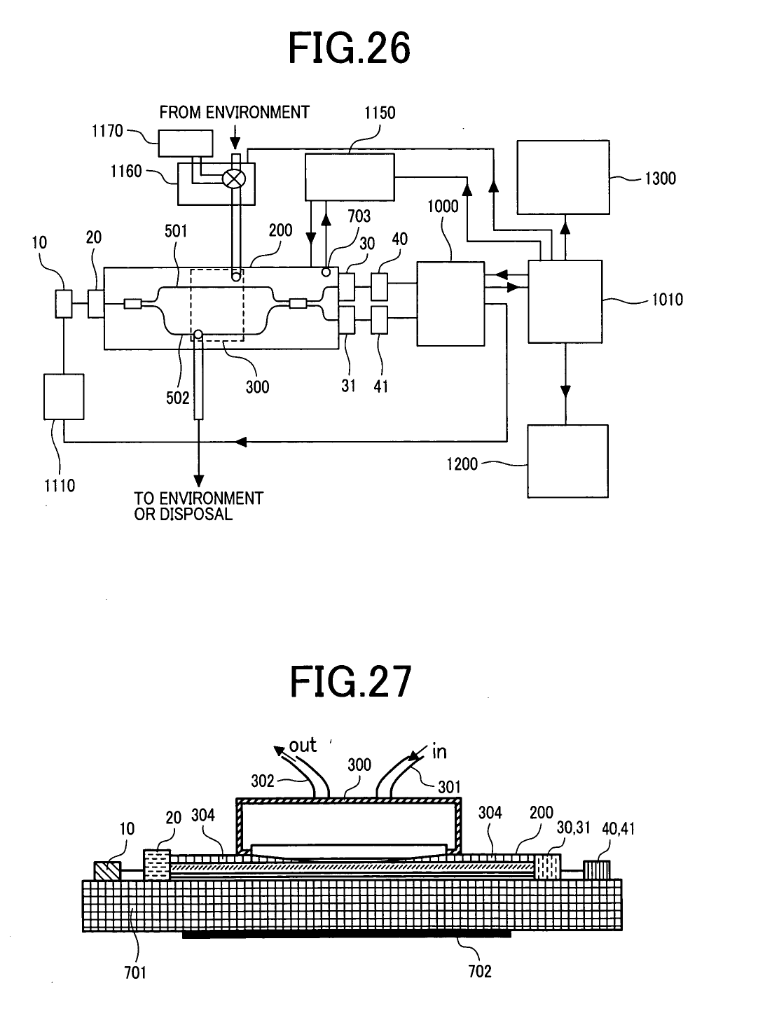

Next, referring to FIG. 26, the flow of a signal in the whole sensor will be described. First, a solvent stored in 1170 for comparison and including no target compound such as deionized water is made to flow into the reaction chamber 305. The flow is controlled via a flow controller 1150 from a measurement controller 1010. At this time, the laser source 10 inputs an optical signal to the optical waveguide substrate 200. The output of the photodetectors 40, 41 is input to an output arithmetic and control unit 1000 corresponding to ambient temperature and others. A signal is sent to a wavelength controller 1110 so that (PD1−PD2)/(PD1+PD2) is 0 and control is transferred to an operating point shown in FIG. 16. Next, the flow controller switches to a flow from measured environment so as to lead the target compound 602 into the reaction chamber 305. At this time, the wavelength of the light source 10 remains constant. According to the concentration of the target compound, (PD1−PD2)/(PD1+PD2) varies. The output signal is sent to the measurement controller 1010 and the output related to the concentration of the target compound is transmitted to a display 1200 and another terminal 1300 on a network, referring to data for converting measurement data acquired by calibration to the concentration of the target compound. Needless to say, the temperature of the substrate 200 and the temperature of the reaction chamber 305 are controlled using the temperature controller 1150 so that each temperature of the substrate and the reaction chamber is constant to maintain the equilibrium state between the target compound 602 and the specific receptor 601. The peltier cooler 706 and others are used for controlling temperature and a thermistor-thermometer and others are used for monitoring temperature.

Such a dioxin sensor is produced, the sensing of the minute variation of 10⁻¹⁰ in terms of a response of a refractive index succeeds and the measurement of PPB or sub-ppb is enabled using the second antibody.

Second Embodiment

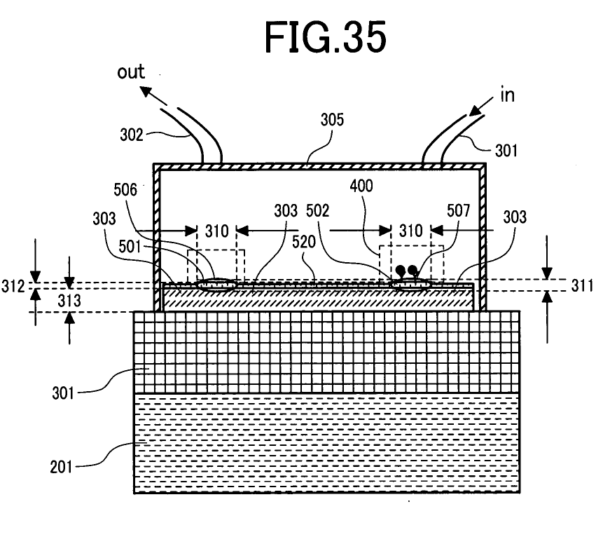

The configuration of a sensor chip equivalent to a second embodiment of the invention will be described below. In this embodiment, an example having such sectional structure as the width of an optical spot confined in an optical waveguide is not determined by a first core forming the optical waveguide but is determined by the width of a ridge which can be processed by etching the first core layer will be described. FIG. 35 is a sectional view showing a sensor.

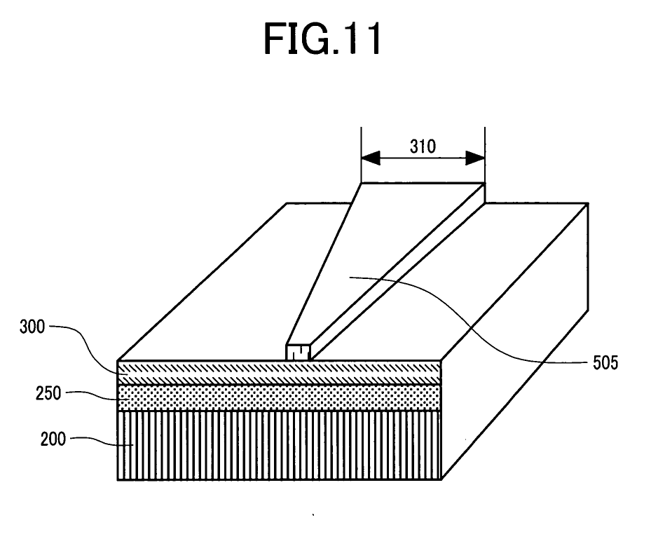

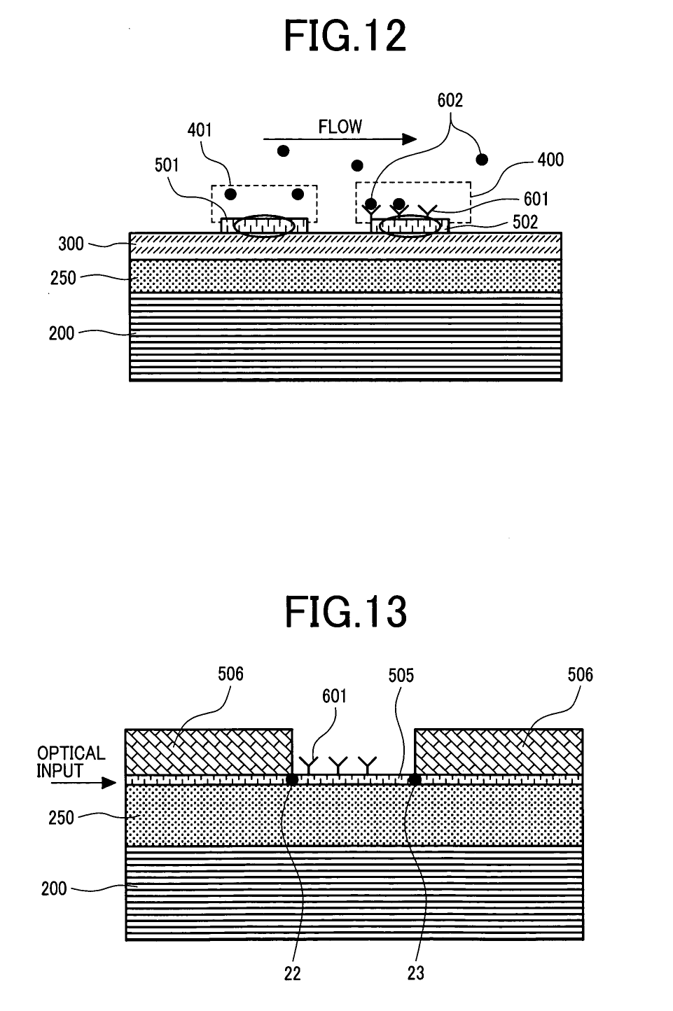

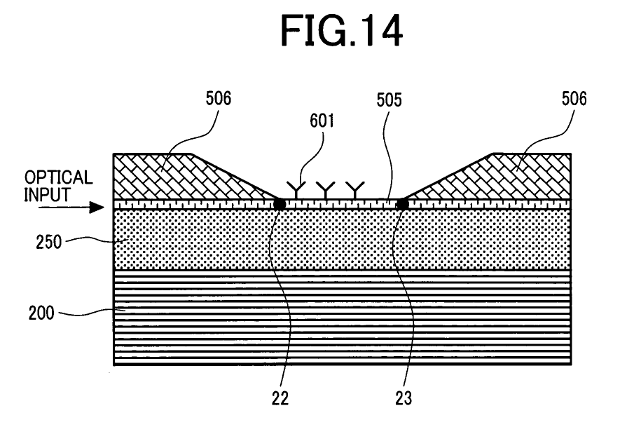

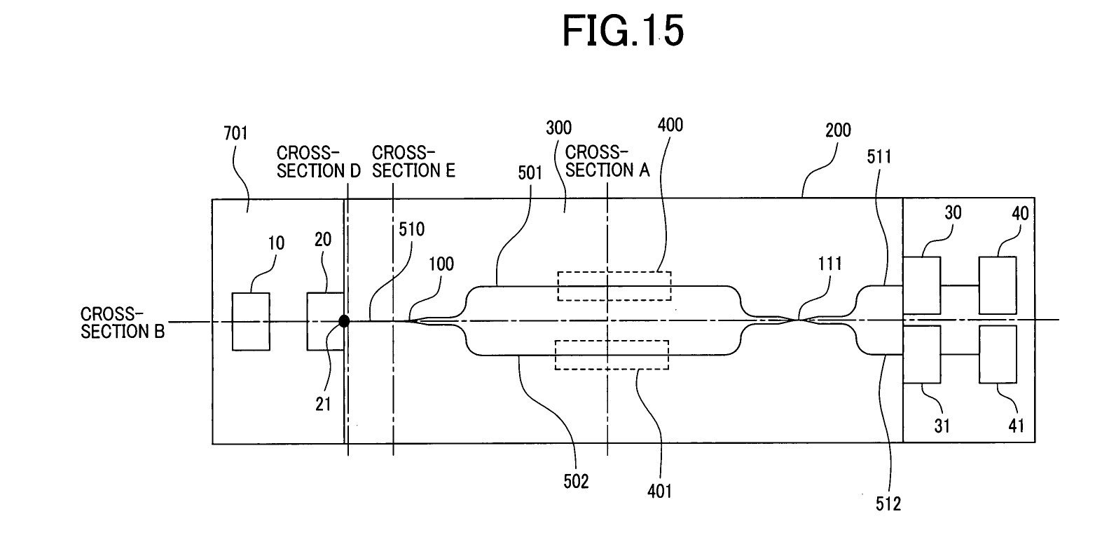

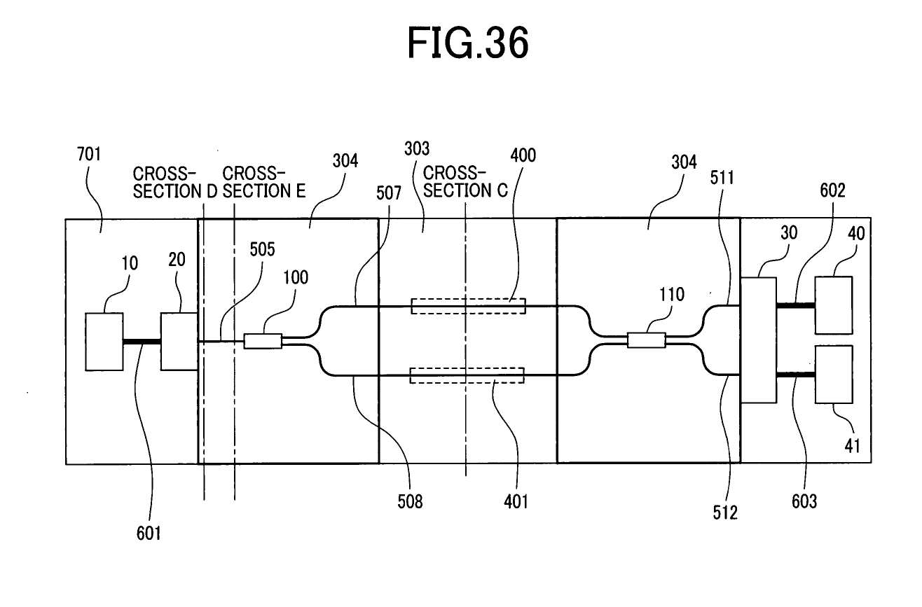

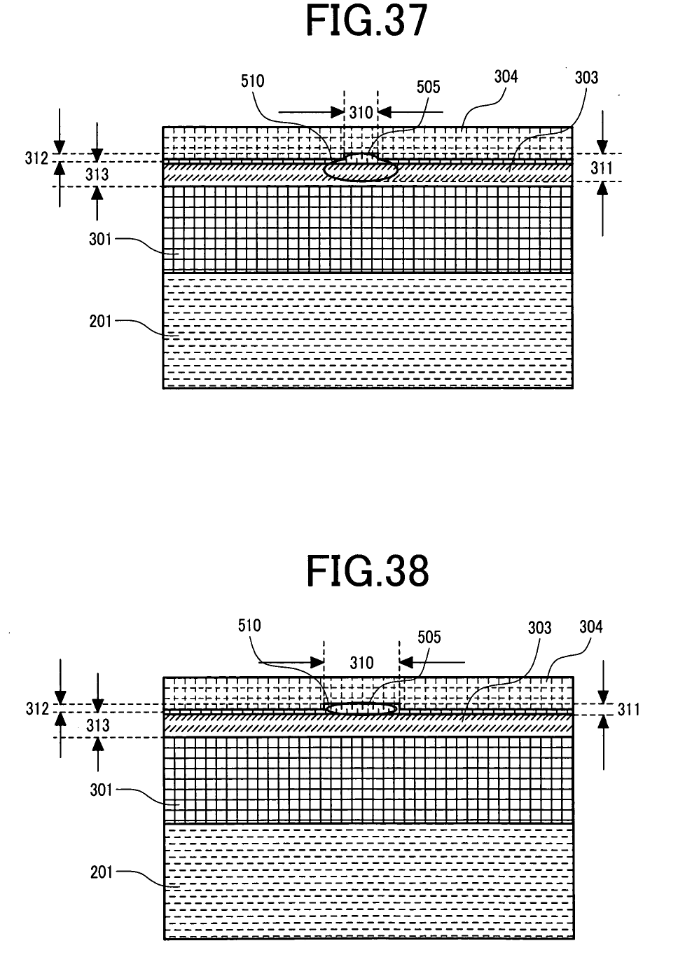

The first core layer 520 continues without being separated into an optical waveguide 501 and an optical waveguide 502. The first core layer produces ridge structure in the optical waveguide 501 and the optical waveguide 502. Because of the ridge structure, an optical spot confined in the optical waveguide has width defined by the width of the ridge such as 506 and 507. The thickness of the first core layer is set to 300 nm in a thick part forming the ridge and is set to 150 nm in a thin part without the ridge. As the first core layer continues, a second core layer is also extended on the whole substrate. However, it does not come into question whether or not the first and second core layers exist in an area fully apart from the waveguide in which an input beam does not reach. The top view of the sensor chip is similar to FIG. 19 in the first embodiment and FIG. 36 shows it. A system of the whole sensor chip is also the same as the system in the first embodiment. Next, referring to FIGS. 37 and 38, the structure of the optical waveguide in a part in which a beam is input will be described. FIG. 37 is a sectional view viewed along a cross-section D in FIG. 36 and FIG. 38 is a sectional view viewed along a cross-section E. The width 310 of the ridge is narrower on the cross-section D, compared with the width on the cross-section E. This is because the input optical waveguide is tapered as shown in FIG. 11. In this embodiment, as the first core layer and the second core layer are larger by a few times or more, compared with the width of an optical spot confined in the optical waveguide and the width of the optical spot is not defined, the optical spot is too large because only the first core confines the beam in a transverse direction when the spot tries to be fitted to an optical fiber for example for optical coupling with an external light source to be 10 mm in size. In the meantime, in a vertical direction (a direction perpendicular to the substrate), as the first core layer is widely left, the optical spot cannot be sufficiently widened. However, compared with a case without tapered structure, the degree of the nonconformance of spot size is small and leakage is also inhibited. Therefore, the fluctuation of the beam can be inhibited, compared with that in the conventional type and the sensitivity can be enhanced.

Third Embodiment

The configuration of a sensor chip equivalent to a third embodiment of the invention will be described below. FIG. 27 is a sectional view corresponding to the cross-section B. In the configuration equivalent to this embodiment, multipath reflection on the end face of a protective film 304 is inhibited. PDMS Polydimethylsiloxane is shaped by pouring PDMS material in a mold made of Si and heating it at 200° C. while applying the pressure of 104 Pa. Hereby, the protective film 304 including the tapered structure the thickness of which smoothly varies is produced. A reflectance at a location at which the protective film is cut can be inhibited up to 10⁻⁶ or less by adopting the tapered structure. In this embodiment, a waveguide under the tapered structure of the protective film 304 has the same sectional structure as that of the sensor and the structure is the same as that in FIG. 23. The width of a first core layer is set to 6 μm, however, it need scarcely be said that the width is narrowed up to 3.8 μm, an optical spot is extended up to a second core layer 303, and a reflectance can be further inhibited.

Fourth Embodiment

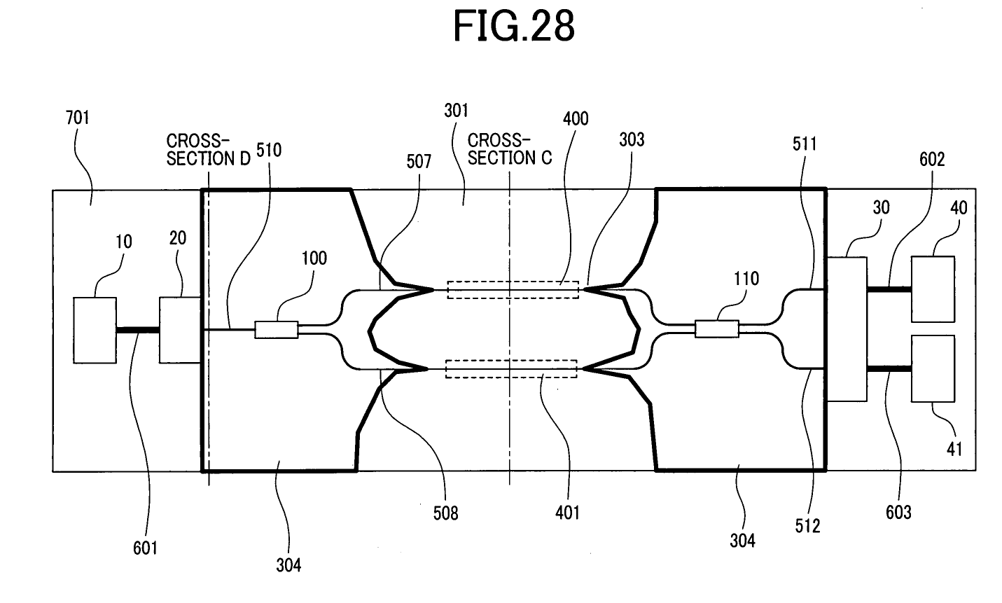

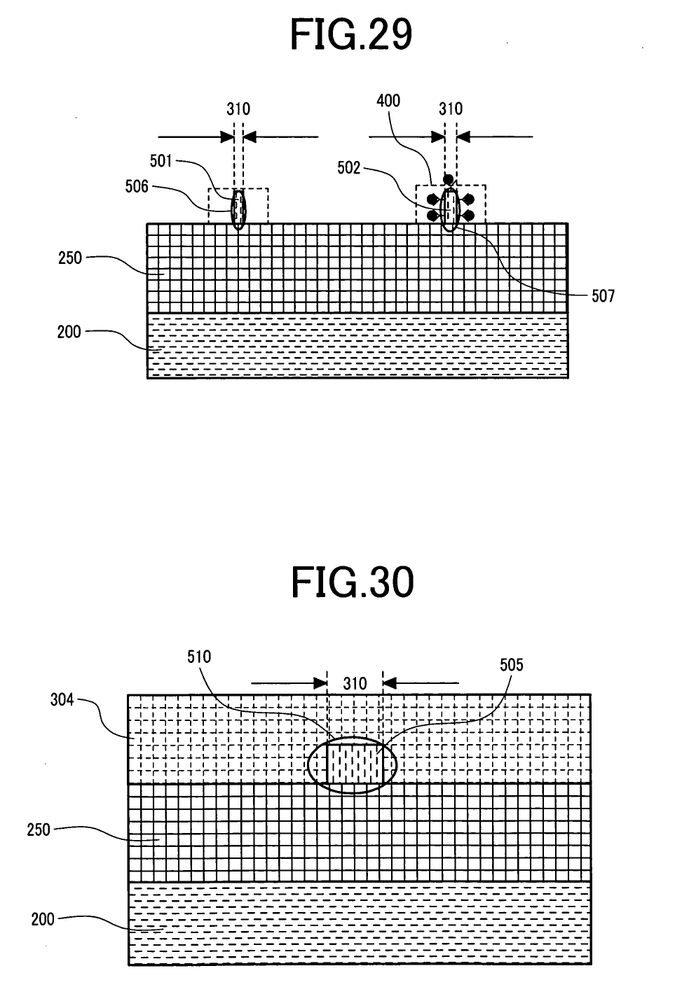

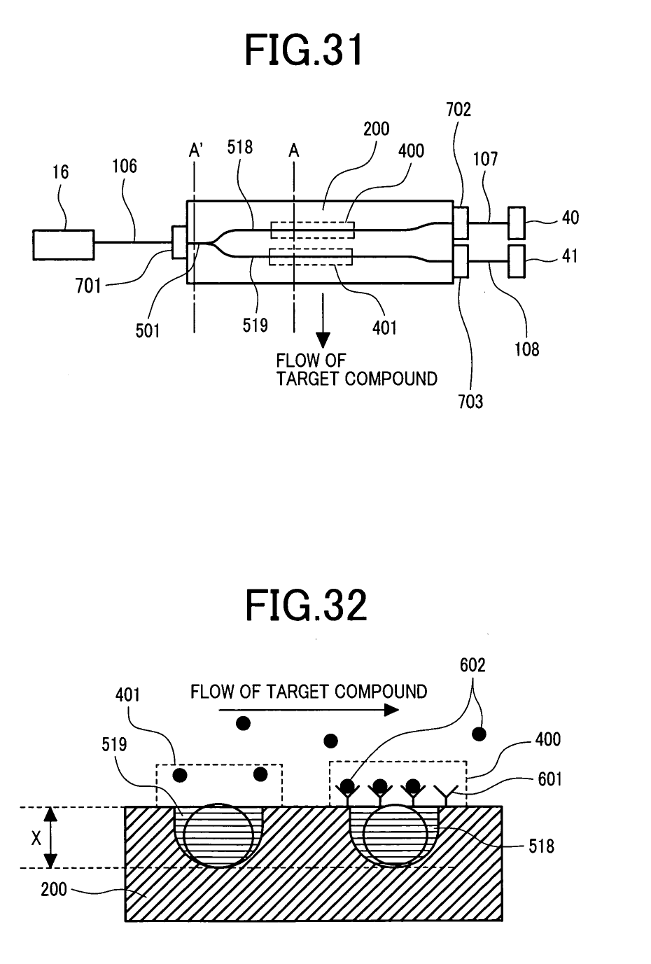

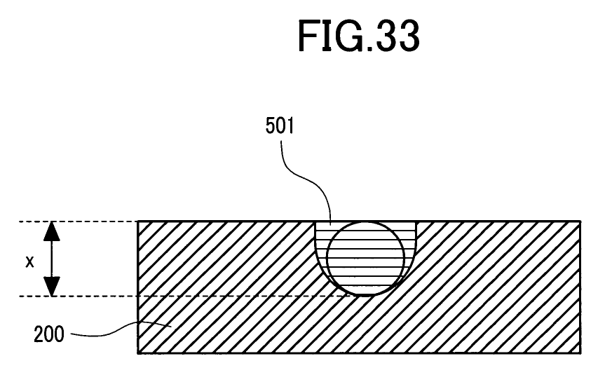

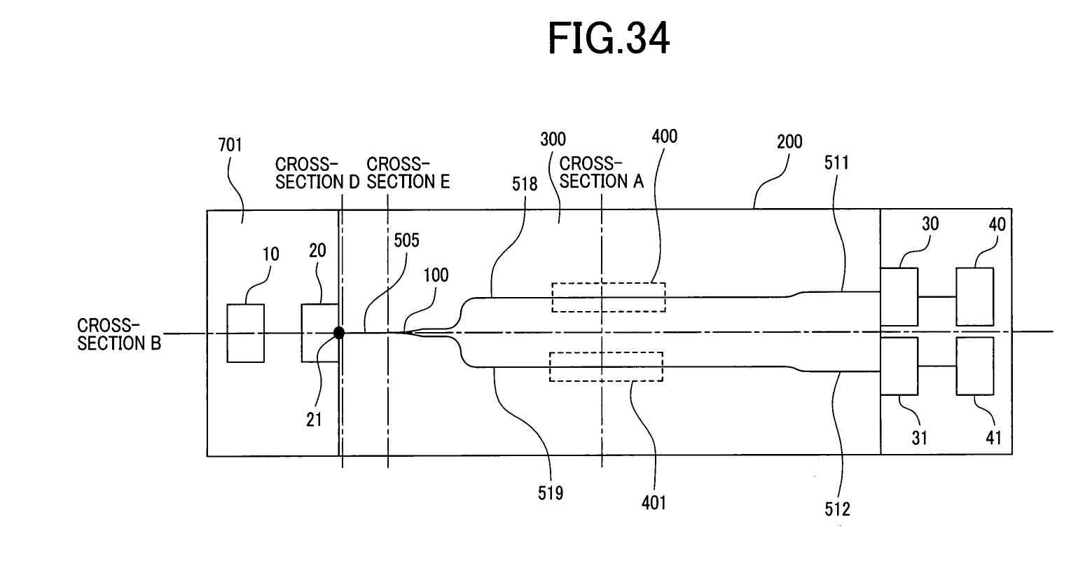

In this embodiment, further, an example that sensitivity can be enhanced by vertically extending a thin film will be described below. FIG. 28 which is a top view is substantially the same as FIG. 19 is the top view, however, a second core layer 303 is removed because of simplification. A protective film 304 made of PDMS inhibits reflection at a location at which the protective film is cut by adopting tapered structure in a plane of a substrate shown in FIG. 28. FIG. 29 is a sectional view viewed along a cross-section C shown in FIG. 28. Polymer material with 15 mm thick is applied on the Si substrate 200, a cladding layer 250 and next, polyimide material (refractive index: 1.8) are applied by 4 mm by heat-cure, width 310 is etched by 0.3 μm by reactive ion etching and waveguides 501, 502 are formed. A core layer 505 is set in such size as is fitted to spot size of a fiber in width and thickness as shown in FIG. 30 which is a sectional view viewed along a cross-section D shown in FIG. 28. In an area 400, an antibody to be a specific receptor is immobilized on the side and the top face of the waveguide 502. Hereby, antibodies are immobilized on three sides and the sensitivity can be enhanced approximately twice.

Fifth Embodiment

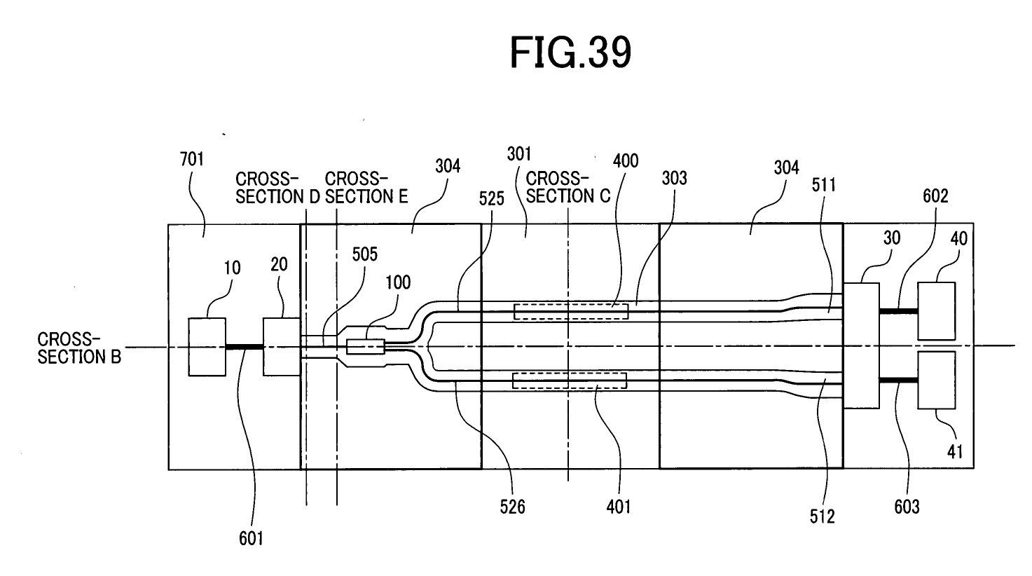

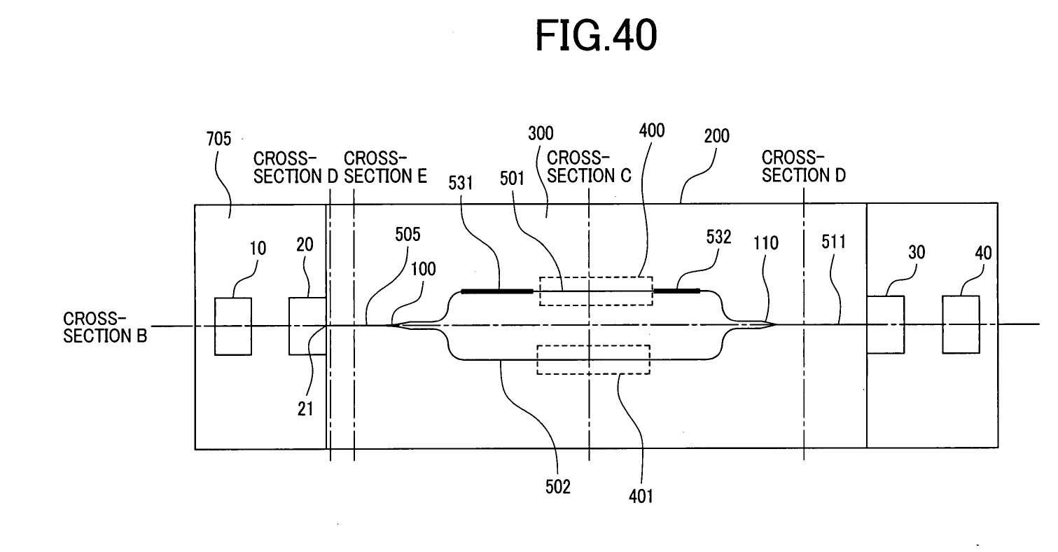

Next, configuration that a target compound is sensed by measuring not a response of the refractive index by the adsorption of a target compound in the surface of an optical waveguide but a response of the absorption coefficient will be described. In this embodiment, leakage is reduced by configuring a tapered optical waveguide in input/output parts of a light absorption type chemical sensor and the sensitivity can be enhanced by inhibiting optical fluctuation. FIG. 39 is a top view showing a sensor chip corresponding to this embodiment. FIG. 39 is different from FIG. 19 which is the top view showing a Mach-Zehnder chemical sensor in that after a beam input from the tapered input optical waveguide is branched at MMI for branching, it is propagated in optical waveguides 525, 526 and is led to optical output waveguides 511, 512 without being multiplexed. The detailed method is the same as that in the first embodiment. A target compound can be sensed not only by measuring a response of the absorption coefficient of the optical waveguide by the adsorption of the target compound in a specific receptor but by measuring a response of the absorption coefficient of the optical waveguide by the adsorption of a complex with a marker in the specific receptor. It need scarcely be said that for another variation, a phenomenon that the structure of the specific receptor varies by the adsorption of the target compound in the specific receptor and an absorption coefficient varies can be utilized. As a method of processing a signal is slightly different from the case of the Mach-Zehnder interferometer, it will be described below.

In case a response of an absorption coefficient is measured, optical intensity is directly proportional to the adsorbed amount of the target compound. Therefore, as a rule, the variation of optical intensity is checked correspondingly to the adsorbed amount beforehand and the adsorbed amount can be calculated by referring to the result in measurement. However, considering that there may be a case that the adsorbed amount increases or decreases by the effect of the target compound except the adsorption, a method of sensing difference between the output which is optical output from the optical waveguide for reference 526 of a photodiode 41 and the output which is optical output from the optical waveguide for the sensor 525 of a photodiode 40 and calculating the adsorbed amount is more precise.

The system configuration is the same as that shown in FIG. 26 and is different only in that (PD1−PD2) is measured in place of (PD1−PD2)/(PD1+PD2).

According to the embodiments of the invention, the sensitivity of the Mach-Zehnder interferometer-type chemical sensor can be enhanced. More concretely, the sensitivity can be enhanced with the small-sized chemical sensor and stable operation.

Additional Notes:

1. A chemical sensor according to the invention is characterized in that

an optical input waveguide, an optical output waveguide and

a Mach-Zehnder interferometer provided between the optical input waveguide and the optical output waveguide and provided with first and second intermediate waveguides connected via first and second branchpoints branched in two are provided on a substrate,

a specific receptor specifically bound with a target compound is provided on the surface of at least a part of the first intermediate waveguide,

out of the waveguides, at least the optical input waveguide is provided with a cladding layer, a first core layer the refractive index of which is higher than material forming the cladding layer and a second core layer the refractive index of which is higher than material forming the first core layer respectively provided on the substrate in the order and the second core layer is wider than the first core layer.

2. A chemical sensor according to the invention is characterized in that

an optical input waveguide, an optical output waveguide and

a Mach-Zehnder interferometer provided between the optical input waveguide and the optical output waveguide and provided with first and second intermediate waveguides connected via first and second branchpoints branched in two are provided on a substrate,

a specific receptor specifically bound with a target compound is provided on the surface of at least a part of the first intermediate waveguide, and

gas or liquid including the target compound is directly touched to the specific receptor on at least two faces out of the top face and the sides of at least the first intermediate waveguide out of the waveguides.

3. A chemical sensor according to the invention is characterized in that

an optical input waveguide, an optical output waveguide,

first and second intermediate waveguides connected via first and second branchpoints branched in two are provided,

a specific receptor specifically bound with a target compound is provided on the surface of at least a part of the first intermediate waveguide,

at least one of the width and the thickness of the optical input waveguide in a connection of the optical input waveguide and the first branchpoint is smaller than at least one of the width and the thickness of the optical input waveguide in the vicinity of the end on the side reverse to the connection of the optical input waveguide and the first branchpoint, and

at least one of the width and the thickness of the first and second intermediate waveguides is smaller than at least one of the width and the thickness of the optical input waveguide in the vicinity of the end on the side reverse to the connection of the optical input waveguide and the first branchpoint.

4. A chemical sensor according to a third aspect is characterized in that

at least the first immediate waveguide out of the waveguides is provided with a cladding layer, a first core layer the refractive index of which is higher than material forming the cladding layer and a second core layer the refractive index of which is higher than material forming the first core layer respectively provided in the order, and the second core layer is thinner than the first core layer.

5. A chemical sensor according to the invention is characterized in that

an optical input waveguide, an optical output waveguide,

first and second intermediate waveguides provided between the optical input waveguide and the optical output waveguide and connected via first and second branchpoints branched in two are provided,

a specific receptor specifically bound with a target compound is provided on the surface of at least a part of the first intermediate waveguide,

at least the optical input waveguide out of the waveguides is provided with a cladding layer, a first core layer the refractive index of which is higher than material forming the cladding layer, and a second core layer the refractive index of which is higher than material forming the first core layer, respectively provided on a substrate in the order, and the second core layer is wider than the first core layer.

6. A chemical sensor according to the invention is characterized in that

an optical input waveguide, an optical output waveguide,

first and second intermediate waveguides provided between the optical input waveguide and the optical output waveguide and connected via first and second branchpoints branched in two are provided,

a specific receptor specifically bound with a target compound is provided on the surface of at least a part of the first intermediate waveguide, and

gas or liquid including the target compound is directly touched to the specific receptor on at least two faces out of the top face and the sides of at least the first intermediate waveguide out of the waveguides.

What is claimed is:

1. A chemical sensor, wherein:
an optical input waveguide, an optical output waveguide and a Mach-Zehnder interferometer provided between the optical input waveguide and the optical output waveguide and provided with first and second intermediate waveguides connected via first and second branchpoints branched in two are provided on a substrate;
a specific receptor specifically bound with a target chemical compound is provided on the surface of at least a part of the first intermediate waveguide;
at least one of the width and the thickness of the optical input waveguide in a connection of the optical input waveguide and the first branchpoint is larger than at least one of the width and the thickness of the optical input waveguide in the vicinity of the end on the side reverse to the connection of the optical input waveguide and the first branchpoint; and
at least one of the width and the thickness of the first and second intermediate waveguides is larger than at least one of the width and the thickness of the optical input waveguide in the vicinity of the end on the side reverse to the connection of the optical input waveguide and the first branchpoint.

2. A chemical sensor according to claim 1, wherein:
at least one of the width and the thickness of the optical output waveguide in the connection of the optical output waveguide and the second branchpoint is larger than at least one of the width and the thickness of the optical output waveguide in the vicinity of the end on the side reverse to the connection of the optical output waveguide and the second branchpoint.

3. A chemical sensor according to claim 1, wherein:
at least one of the width and the thickness of the optical input waveguide is set so that it monotonously increases or monotonously decreases in a longitudinal direction of the waveguide.

4. A chemical sensor according to claim 2, wherein:
at least one of the width and the thickness of the optical output waveguide is set so that it monotonously increases or monotonously decreases in the longitudinal direction of the waveguide.

5. A chemical sensor according to claim 1, wherein:
at least the first intermediate waveguide out of the waveguides is provided with a cladding layer, a first core layer the refractive index of which is higher than material forming the cladding layer and a second core layer the refractive index of which is higher than the material forming the first core layer respectively provided in the order; and
the second core layer is thinner than the first core layer.

6. A chemical sensor according to claim 5, wherein:
a specific receptor is provided on the second core layer forming the first intermediate waveguide.

7. A chemical sensor according to claim 5, wherein:
passivating coating is provided to at least a part on the second core layer of at least one of the optical input waveguide and the optical output waveguide.

8. A chemical sensor according to claim 1, wherein:
optical waveguides forming the Mach-Zehnder interferometer have a birefringent characteristic.

9. A chemical sensor according to claim 5, wherein:
the second core layer is made of material having a birefringent characteristic.

10. A chemical sensor, wherein:
an optical input waveguide, an optical output waveguide and a Mach-Zehnder interferometer provided between the optical input waveguide and the optical output waveguide and provided with first and second intermediate waveguides connected via first and second branchpoints branched in two are provided on a substrate;
a specific receptor specifically bound with a target compound is provided on the surface of at least a part of the first intermediate waveguide; and
at least one of the width and the thickness of the first intermediate waveguide in a connection of the first intermediate waveguide and the first branchpoint is smaller than at least one of the width and the thickness of the first intermediate waveguide in the center of the first intermediate waveguide.

11. A chemical sensor according to claim 10, wherein:
at least one of the width and the thickness of the second intermediate waveguide in the connection of the second intermediate waveguide and the first branchpoint is smaller than at least one of the width and the thickness of the second intermediate waveguide in the center of the second intermediate waveguide.

12. A chemical sensor according to claim 10, wherein:
at least one of the width and the thickness of the first intermediate waveguide in the connection of the first intermediate waveguide and the second branchpoint is larger than at least one of the width and the thickness of the first intermediate waveguide in the center of the first intermediate waveguide.

13. A chemical sensor according to claim 10, wherein:
at least one of the width and the thickness of the second intermediate waveguide in the connection of the second intermediate waveguide and the second branchpoint is smaller than at least one of the width and the thickness of the second intermediate waveguide in the center of the second intermediate waveguide.

14. A chemical sensor according to claim 10, wherein:
at least one of the width and the thickness of at least one of the first and second intermediate waveguides is provided with a first part that monotonously decreases in a longitudinal direction of the waveguide; and
at least one of the width and the thickness of at least one of the first and second intermediate waveguides is provided with a second part that monotonously increases ahead of the first part.

15. A chemical sensor according to claim 10, wherein:
at least the first intermediate waveguide out of the waveguides is provided with a cladding layer, a first core layer the refractive index of which is higher than material forming the cladding layer, and a second core layer the refractive index of which is higher than material forming the first core layer, respectively provided in the order on a substrate; and
the second core layer is thinner than the first core layer.

16. A chemical sensor according to claim 15, wherein:
a specific receptor is provided on the second core layer of the first intermediate waveguide.

17. A chemical sensor according to claim 15, wherein:
a protective film is provided to at least a part on the second core layer of at least one of the optical input waveguide and the optical output waveguide.

18. A chemical sensor according to claim 10, wherein:
an optical waveguide forming the Mach-Zehnder interferometer is provided with a birefringent characteristic.

19. A chemical sensor according to claim 15, wherein:
the second core layer is made of material having a birefringent characteristic.

20. A chemical sensor according to claim 1, wherein:
gas or liquid including the target compound is directly touched to the specific receptor.
